(19) United States
(12) Patent Application Publication
(10) Pub. No.: US 2007/0163259 A1
(43) Pub. Date: Jul. 19, 2007

(54) Fluid Linkage for Mechanical Linkage Replacement and Servocontrol

(75) Inventor: Timothy David Webster, Saskatoon (CA)

Correspondence Address: Timothy D. Webster;Virtual Infinity Inc., 101 Capilano Court, Saskatoon, SK, S7K 4B9, CA

(73) Assignee: Timothy Webster, Saskatoon (CA)

(21) Appl. No.: 11/306,469

(22) Filed: Dec. 29, 2005

(51) Int. Cl. F02G 3/00

(52) U.S. Cl. 60/623

(57) ABSTRACT

A fluid linkage allows for coordinated movement of mechanical components separated by a distance. In applications where accurate coordination is required, a mechanism called a limit-switch valve (180) is activated at specific actuator positions. The limit-switch valves are able to detect fluid loss in the fluid linkage between the actuators and compensate for this fluid loss. A volume displacement servomechanism is created by connecting pressure actuators (360, 361) of a fluid control valve (120) to a control actuator (133). A basic position feedback servomechanism is created by connecting pressure actuators (362, 363) of a fluid control valve (150) to a control actuator (135) and a feedback actuator (145). The fluid control valve (150) controls the servomotor actuator (146) to which the feedback actuator (145) is attached. A position tactile feedback servomechanism allows an operator to perceive the load on the servomotor actuator (146) by its reflection on the control actuator (135). This tactile feedback is created by connecting tactile feedback actuators (364, 365) to the fluid servomotor (146). Accurate servo action is achieved through the use of limit-switch valves. The fluid linkage and limit-switch valve are extremely useful in self-leveling, steering linkage replacement, aerodynamic control surface servomechanisms, and many more applications.

### BACKGROUND OF THE INVENTION—FIELD OF INVENTION

This invention relates to utilizing a fluid linkage to replace complex mechanical linkages, which can be used for an articulating hitch, steering, self-leveling, and other systems.

### BACKGROUND OF THE INVENTION—DESCRIPTION OF PRIOR ART

Mechanical linkages, which connect moving parts together to coordinate their movement, are often very complex or prohibitively complex. Fluid linkages provide an alternative means of coordinating the movement of mechanical parts. Current systems use either a mechanical linkage or hydraulic flow divider valves. To fully understand the disadvantages of mechanical linkages, some existing systems that use mechanical linkages should be considered.

Although mechanical linkages used for steering linkages are reliable and effective, they have many shortcomings:
The vehicle design must accommodate a mechanical linkage connecting the left and right turning wheels together. This mechanical linkage is required so the turning wheels can turn in a coordinated manner. This is known as a mechanical steering linkage. Vehicles designed to accommodate a mechanical steering linkage often have complex mechanical steering linkage geometries. This leaves the mechanical steering linkage exposed and susceptible to damage. Holes in the vehicle frame are often required, which weaken the mechanical steering linkage. These are just a few of the problems posed by mechanical steering linkages.
A mechanical linkage is required between the operator's steering wheel and turning wheels. In an accident, the front turning wheels can get pushed backward, thus forcing the steering linkage backward and pushing the steering wheel into the driver. A collapsible steering linkage is required to prevent this from happening.
Once a mechanical steering system is in place, it is difficult to disable it. When driving on the road, one only wants to steer with the front wheels. However, during parallel parking, it is highly desirable to be able to steer with both the front and rear wheels.
Trailers are not steerable, because it is too complex and costly to use a mechanical linkage to link steerable trailer wheels to the vehicle steering. Unsteerable trailers required large turning areas, are difficult to maneuver and can push the attached vehicle off course.
It is too costly and complex to use a mechanical linkage to connect the steerable turning wheels of a vehicle to the steerable system. This is why a mechanical linkage system is not currently used to coordinate steerable trailer wheels with the vehicle steering system. Many advantages can be obtained from coordinated vehicle and trailer steering. Without trailer steering the trailer does not follow in the vehicle's path around corners, as a result substantially space is required to maneuver the vehicle and trailer around corners.

Conventional self-leveling bucket loader designs use either a mechanical linkage or hydraulic flow divider valves. Hydraulic flow divider valves require adjustment, turning, and provide the truly coordinated movement required for precise self-leveling.

The first of the two methods currently employed to achieve self-leveling is a mechanical linkage used to connect a bucket tip hydraulic cylinder to the frame of a vehicle. This has several disadvantages:
The mechanical linkage introduces extra complexity and cost.
The mechanical linkage reduces loader frame geometries available to the designer.
If using a telescopic loader, it is not possible to use a mechanical linkage to connect a bucket tip hydraulic cylinder to the frame of a vehicle.

The second method currently employed to achieve self-leveling is the use of hydraulic flow divider valves to divide hydraulic fluid flow between a lift cylinder and bucket tip hydraulic cylinder. This has several disadvantages too:
Hydraulic flow dividers require continual adjustment and tuning to keep working properly.
Because hydraulic flow dividers do not provide truly accurate coordination of the bucket tip hydraulic cylinder and hydraulic lift cylinder, some operator correction is required. This is not suitable for high precision self-leveling tasks.

Current systems using either a mechanical linkage or hydraulic flow divider valves have limitations. Mechanical linkages are complex and impose significant design restrictions. Hydraulic flow divider valves that require adjustment and tuning do not compensate for fluid leakage.

### BACKGROUND OF THE INVENTION—OBJECTS AND ADVANTAGES

The fluid linkage referred to here links piston actuators or fluid motors together through a hydraulic or pneumatic circuit. Fluid displaced by piston actuator or fluid motor movement is supplied to other piston actuators or fluid motors, thereby causing them to move a corresponding amount. The parts move in a coordinated manner as a result of their fluid linkage. The object of the invention is to provide fluid linkages useful for coordinated movement of mechanical parts in self-leveling, steering linkage replacement, aerodynamic control surface servomechanisms, and many more applications. Unlike conventional hydraulic flow divider valves that require adjustment and tuning, the fluid linkage described here is in many ways simpler than hydraulic flow control valves. By using limit-switch valves, the fluid linkage can include leakage location detection, leakage compensation, and allow the operator to have accurate control over extension and retraction of the piston in the piston actuator. To fully understand the advantages of fluid linkages, some existing systems that could benefit from fluid linkages should be considered.

A steering system based on a fluid linkage offers a number of advantages:
A steering system based on a fluid linkage simplifies design. It is much simpler and allows the design engineer more flexibility on how turning wheels are attached to a vehicle. There is no need to accommodate a mechanical linkage that connects the left and right turning wheels together and there is no need for a mechanical linkage that connects the operator's steering wheel to the vehicle's turning wheels.
The left and right turning wheels can be connected without a mechanical linkage. There is no need to penetrate the body of the vehicle with a mechanical linkage. As a result, the body will be stronger and can easily be made airtight and waterproof.
There is no requirement to protect an external mechanical steering linkage from road hazards.
No space is needed to accommodate connecting the mechanical steering linkage.
No mechanical linkage is required between the operator's steering wheel and the vehicle's turning wheels. Therefore, no collapsible steering linkage is required.
Trailer wheels can easily be steered in coordination with the vehicle. This allows for reduced turning radius and much improved handling. The trailer can follow in the tracks of the towing vehicle, so there is no need to take wide turns around corners.
It is easy to coordinate the turning wheels of the trailer to the turning wheels of the vehicle. Also, it is easy to disable the coordination by disconnecting couplings or stopping fluid flow through valves.
It is possible to coordinate the turning of the vehicle and turning of the trailer, so that the trailer tracks the same wheel path as the vehicle. This allows for different modes of operation to be selected depending on the speed of the vehicle or the desired handling characteristics of the operator, whereas a mechanical linkage system can only be efficiently designed for one mode of operation:
   a. The steering system can be designed such that on soft surfaces, the trailer wheels can be designed to track the vehicle wheels. Substantially less pulling power is required when the trailer follows in the path already cut by the pulling vehicle.
   b. The steering system can be designed such that when passing a vehicle, the trailer wheels will steer with the vehicle wheels to a lesser degree to reduce vehicle spinning, fishtailing, and jackknifing induced by lane changes.
   c. The steering system can be designed such that when parking a vehicle, the trailer wheels can be steered in the same direction as the vehicle wheels or in the opposite direction of the vehicle wheels. Also, the trailer wheels can be left stationary. This versatility allows much greater mobility of the vehicle and trailer in parking.
Similarly, other front and rear attachments like a snowplow, snowblower, or mower can be hooked up to a vehicle and also steered.
Two or more vehicles can even be hooked together then steered and operated as single vehicle.
It is possible to add complete redundancy to the steering system through identical but independent fluid linkage circuits.

The advantages of using a fluid linkage for self-leveling are as follows:
No mechanical linkage is required. It is replaced by a fluid linkage, which is much simpler and cost effective.
A fluid linkage can be used at the end of a telescopic loader. The fluid linkage can be used to connect a bucket tip hydraulic cylinder at the end of a telescopic loader to the hydraulic lift cylinders.
It is possible to use a fluid linkage to construct a self-leveling system with a multiple piece lift arm. Several hydraulic lift cylinders will be used to control the multiple piece lift arm. The fluid displaced by these multiple hydraulic lift cylinders from the multiple piece lift arm can be combined to control the self-leveling bucket tip hydraulic cylinder.
Unlike conventional hydraulic flow divider valves that require adjustment and tuning, the fluid linkage described here incorporates self-correction for fluid leakage.
In many applications, the operator would benefit greatly by the ability to feel a feed load on the control actuator proportional to servomotor actuator load.
The ability to feel the load on vehicle turning wheels would assist the operator detect a reduction of wheel grip, thereby help control and prevent skidding more effectively.
Similarly, an ability to feel the load on aerodynamic control surfaces would allow the operator to control and prevent stall.
Also, the ability of a crane or excavator operator to feel load would allow the operator to perform very delicate work safely.

Still further objects and advantages of this invention will become apparent from a consideration of the drawings and ensuing description.

### SUMMARY

In accordance with the present invention, a fluid linkage circuit comprises of piston actuators or fluid motors that are displaced by fluid and/or displace fluid, fluid control valves that determine the direction of piston actuators and/or fluid motors by establishing the direction of fluid flow, and fluid conduits for connecting piston actuators and/or fluid motors with possible intermediary fluid control valves and boost pumps. This fluid linkage circuit forcibly correlates the motion of piston actuators or fluid motors to provide an effective replacement for mechanical linkages.

### DRAWINGS—FIGURES

In the drawings, closely related figures have the same number but different alphabetic suffixes.

FIG. 1 shows a fluid linkage circuit with linear fluid actuators and limit-switch valves for leakage compensation, leakage location detection, and piston extension/retraction limiting.

FIG. 2 is used in describing the linear displacements in a fluid linkage circuit with linear fluid actuators.

FIG. 3 is used in describing the rotational displacements in a fluid linkage circuit with rotary fluid actuators.

FIG. 4 shows a fluid linkage circuit with linear fluid actuators, a boost pump, and limit-switch valves for leakage compensation, leakage location detection, and piston extension/retraction limiting.

FIG. 5A shows a linear actuator servomechanism fluid linkage circuit.

FIG. 5B shows a rotary actuator servomechanism fluid linkage circuit.

FIG. 5C shows a servomechanism fluid linkage circuit without the low-pressure main fluid pump.

FIG. 5D shows a servomechanism fluid linkage circuit with limit-switch valves for leakage compensation, leakage location detection, and piston extension/retraction limiting.

FIG. 6A shows a position feedback servomechanism fluid valve in a fluid linkage circuit.

FIG. 6B shows a servomechanism fluid valve with tactile feedback in a fluid linkage circuit using a feedback linkage between the control piston actuator and drive actuator.

FIG. 6C shows a position feedback servomechanism fluid valve in a fluid linkage circuit using a drive piston actuator supplied by fluid flow splitters.

FIG. 6D shows a position feedback servomechanism fluid valve in a fluid linkage circuit with limit-switch valves for leakage compensation, leakage location detection, and piston extension/retraction limiting.

### DRAWINGS—REFERENCE NUMERALS

110 high-pressure fluid pump

111 high-pressure bidirectional fluid boost pump

112 high-pressure fluid boost pump

113 control circuit fluid pump

120 fluid control valve

121 fluid control valve crossover line

122 fluid control valve straight-through line

125 fluid control valve

126 fluid control valve crossover line

127 fluid control valve straight-through line

130 linear fluid actuator (piston actuator)

131 rotary fluid actuator (fluid motor)

132 linear fluid actuator (piston actuator)

133 low force control piston actuator

134 control rotary fluid actuator (fluid motor)

135 control piston actuator

140 linear fluid actuator (piston actuator)

141 rotary fluid actuator (fluid motor)

142 linear fluid actuator (piston actuator)

143 drive piston actuator

144 control rotary fluid actuator (fluid motor)

145 feedback piston actuator

146 servomotor piston actuator

147 split drive feedback piston actuator

150 pressure activated fluid control valve

151 fluid control valve crossover line

152 fluid control valve disconnect line

153 fluid control valve straight-through line

170 fluid check valve

171 fluid check valve

172 fluid check valve

174 fluid check valve

175 fluid check valve

176 fluid check valve

177 fluid check valve

179 pressure release valve from fluid reservoir to fluid check valves 174 and 175 to fluid control valve 120

180 limit-switch valve attached to base of piston actuator

181 disconnect state

182 connect state

190 limit-switch valve attached to head of piston actuator

191 disconnect state

192 connect state

200 limit-switch valve attached to base of piston actuator 140

201 disconnect state

202 connect state

220 mechanical connection between fluid control valve 120 and fluid control valve 125

221 mechanical or magnetic connection between drive piston actuator and feedback piston actuator that forces the pistons to be extended to the same amount

223 mechanical or magnetic connection between split drive piston actuator and split drive feedback piston actuator that forces the pistons to be extended to the same amount

240 fluid flow splitter to piston actuator head connections

241 fluid flow splitter to piston actuator base connections

250 fluid check valve

252 fluid check valve

260 limit-switch valve attached to base of control actuator 135

261 disconnect state

262 connect state

270 limit-switch valve attached to head of control actuator 135

271 disconnect state

272 connect state

350 mechanical activator that can apply force to limit-switch valve 180, such that it goes to connect state 182

351 mechanical activator that can apply force to limit-switch valve 190, such that it goes to connect state 192

352 mechanical activator that can apply force to limit-switch valve 200, such that it goes to connect state 202

355 mechanical activator applying force to limit-switch valve 260

357 mechanical activator applying force to limit-switch valve 270

360 pressure activator that can apply force to fluid control valve 120, such that it goes to crossover position 121

361 pressure activator that can apply force to fluid control valve 120, such that it goes to straight-through position 122

362 pressure activator applying force to control position of fluid control valve 150, such that it goes to crossover position 151

363 pressure activator applying force to control position of fluid control valve 150, such that it goes to straight-through position 153

364 tactile feedback pressure activator applying resisting force feedback to the control piston actuator 135

365 tactile feedback pressure activator applying resisting force feedback to the control piston actuator 135

602 control-pressure line from control fluid pump 113 to fluid check valves 250 and 252

614 line from the fluid flow splitter 240 to the split drive piston actuator 147 head connection

615 line from the fluid flow splitter 241 to the split drive piston actuator 147 base connection

624 line from the fluid flow splitter 240 to the drive piston actuator 146 head connection

625 line from the fluid flow splitter 241 to the drive piston actuator 146 base connection

634 line from fluid control valve 150 to the fluid flow splitter 240

635 line from fluid control valve 150 to the fluid flow splitter 241

701 intake line to left connection of fluid motor 131; this line could come from a fluid reservoir, fluid pump, fluid control valve, piston actuator, or fluid motor

703 line from right connection of fluid motor 141 to fluid reservoir, fluid boost pump, fluid control valve, piston actuator, or fluid motor

706 line from right connection of fluid motor 131 to left connection of fluid motor 141

714 line from fluid control valve 120 to left connection of fluid motor 144

715 line from fluid control valve 120 to right connection of fluid motor 144

716 low-pressure line from fluid check valves 176 and 177 to high-pressure fluid boost pump 112

726 line from high-pressure fluid boost pump I12 to fluid control valve 120

798 low-pressure line connecting fluid check valve 174, cylinder head connection of low force control rotary actuator 134, and pressure activator 360

799 low-pressure line connecting fluid check valve 175, cylinder base connection of low force control rotary actuator 134, and pressure activator 361

801 intake line to cylinder head connection of piston actuator 132; this line could come from a fluid reservoir, fluid pump, fluid control valve, piston actuator, or fluid motor

803 output line from cylinder head connection of piston actuator 142; this line could go to a fluid reservoir, fluid pump, fluid control valve, piston actuator, or fluid motor

804 line from fluid control valve 120 to cylinder head connection of piston actuator 130 and to fluid check valve 170

805 line from fluid control valve 120 to cylinder head connection of piston actuator 140 and to fluid check valve 172

806 line connecting cylinder base connection of piston actuator 130, cylinder base connection of piston actuator 140, limit-switch valve 180, and limit-switch valve 200

811 fluid return and siphon line from fluid reservoir to pressure release valve

812 line from low-pressure main fluid pump 110 to fluid check valves 174 and 175

818 low-pressure line connecting fluid check valve 174, cylinder head connection of low force control piston actuator 133, and pressure activator 360

819 low-pressure line connecting fluid check valve 175, cylinder base connection of low force control piston actuator 133, and pressure activator 361

828 control pressure line from cylinder head connection of control piston actuator 135 to cylinder head connection of feedback piston actuator 145 and pressure activator 362

829 control pressure line from cylinder base connection of control piston actuator 135 to cylinder base connection of feedback piston actuator 145 and pressure activator 363

832 return line from fluid control valve 120 to fluid check valves 174 and 175 and pressure release valve 179

838 control-pressure line from cylinder head connection of control piston actuator 135 to cylinder head connection of drive feedback piston actuator 145 and pressure activator 362 and to limit-switch valve 270

839 control-pressure line from cylinder base connection of control piston actuator 135 to cylinder base connection of drive feedback piston actuator 145 and pressure activator 363 and to limit-switch valve 260

842 line from fluid pump 110 to fluid control valve 120 and to check valves 170, 171, 174, and 175

846 line from cylinder base connection of piston actuator 130 to high-pressure bidirectional fluid boost pump 111

848 low-pressure line connecting fluid check valve 174, limit-switch valve 190, cylinder head connection of low force control piston actuator 133, and pressure activator 360

849 low-pressure line connecting fluid check valve 175, limit-switch valve 180, cylinder base connection of low force control piston actuator 133, and pressure activator 361

856 line from high-pressure bidirectional fluid boost pump 111 to cylinder base connection of piston actuator 140

858 pilot line connecting the head connection of the tactile feedback pressure actuator 364 to fluid control valve 150 or equivalently to cylinder base connection of piston actuator 146

859 pilot line connecting the head connection of the tactile feedback pressure actuator 365 to fluid control valve 150 or equivalently to cylinder head connection of piston actuator 146

866 low-pressure line from fluid control valve 120 to high-pressure fluid boost pump 111

876 line from high-pressure fluid boost pump 111 to fluid control valve 125

884 line from fluid control valve 150 to cylinder base connection of drive piston actuator 146

885 line from fluid control valve 150 to cylinder head connection of drive piston actuator 146

901 fluid pump 110 intake line from fluid reservoir

902 line from fluid pump 110 to fluid control valve 120

903 return line from fluid control valve 120 to fluid reservoir

904 line from fluid control valve 120 to cylinder head connection of piston actuator 130

905 line from fluid control valve 120 to cylinder head connection of piston actuator 140

906 line from base connection of piston actuator 132 to base connection of piston actuator 142

907 line from limit-switch valve 180 to fluid check valve 170

912 line from high-pressure main fluid pump 110 to fluid control valve 150

913 return line from fluid control valve 125 to fluid reservoir

914 line from fluid control valve 120 to cylinder head connection of drive piston actuator 143

915 line connecting fluid control valve 120, cylinder base connection of piston actuator 130, fluid check valve 171, and limit-switch valve 180

917 line from limit-switch valve 190 to fluid check valve 171

918 low-pressure line from pressure activator 360 to fluid check valve 176

919 low-pressure line from pressure activator 361 to fluid check valve 177

921 fluid control pump 113 intake line from fluid reservoir

923 low-pressure return line from fluid control valve 150 to fluid reservoir

924 line from fluid control valve 125 to cylinder base connection of piston actuator 140

925 line from fluid control valve 125 to cylinder head connection of piston actuator 140

927 line from limit-switch valve 200 to fluid check valve 172

934 line connecting fluid control valve 120, cylinder head connection of piston actuator 130, fluid check valve 170, and limit-switch valve 190

985 line from fluid control valve 120 to cylinder base connection of drive piston actuator 143

### DESCRIPTION OF PREFERRED EMBODIMENTS AND THEIR OPERATIONS

Except where specified, the fluid used in these circuits is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures.

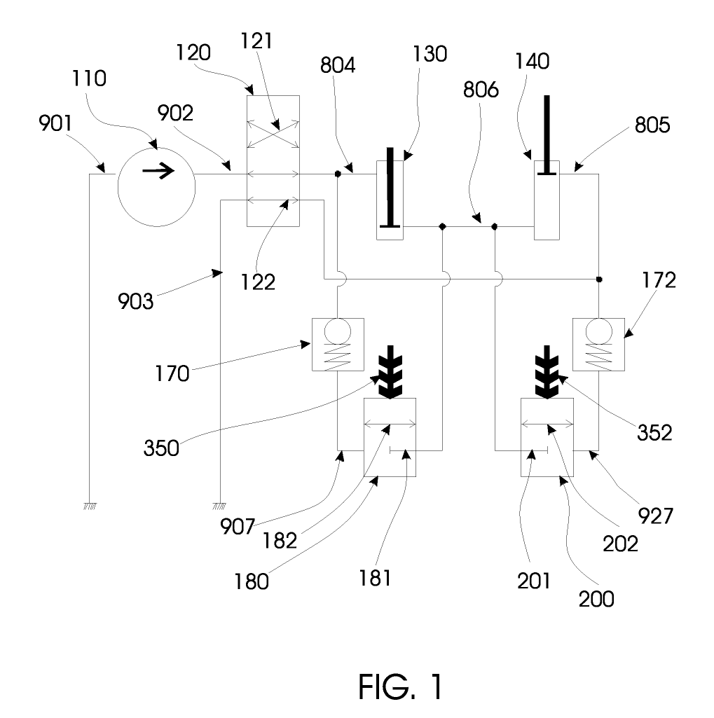

FIG. 1—Description of Fluid Linkage Circuit with Linear Fluid Actuators and Limit-Switch Valves for Leakage Compensation, Leakage Detection, and Piston Extension/Retraction Limiting

Limit-switch valves are used to compensate and correct for fluid loss in the fluid circuit. There are coordinated piston displacements of equal magnitude but opposite direction in each cylinder because of the fluid linkage. Fluid check valves establish unidirectional fluid flow. In addition, limit-switch valves are used for leakage compensation, leakage location detection, and piston extension/retraction limiting.

FIG. 1—Operation of Fluid Linkage Circuit with Linear Fluid Actuators and Limit-Switch Valves for Leakage Compensation, Leakage Detection, and Piston Extension/Retraction Limiting

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

Limit-switch valves can be in either a connect state or disconnect state. In the connect state, fluid flows through the valve. In the disconnect state, fluid flow through the valve is prevented. The limit-switch valve derives its name from its function, which is to switch states as the piston approaches either its extension limit or retraction limit.

Limit-switch valves are used to compensate for fluid loss in the fluid circuit. Fluid loss occurs when there is a leak in the fluid circuit. Normally, as the piston of piston actuator 130 extends, the piston of piston actuator 140 correspondingly retracts by the same displacement volume. Similarly, as the piston of piston actuator 130 retracts, the piston of piston actuator 140 correspondingly extends by the same displacement volume. However, over time when there is fluid leakage in the fluid circuit, the piston displacement volumes will not be the same without leakage compensation.

In addition, a limit-switch valve at the cylinder head connection prevents the piston from overextending and pushing too hard against the cylinder end caps. Similarly, a limit-switch valve at the cylinder base connection prevents the piston from retracting too hard into the cylinder. This extension/retraction limiting reduces wear and tear, thus reducing the need for maintenance and increasing the lifetime of the piston actuator. The function of limit-switch valves is described in more detail below.

Fluid is drawn from the fluid reservoir by high-pressure fluid pump 110 through line 901. Then the fluid is pumped through fluid control valve 120 by way of line 902. There are two possible states for fluid control valve 120: crossover state 121 and straight-through state 122. Crossover state 121 causes the piston of piston actuator 130 to extend and the piston of piston actuator 140 to retract. Straight-through state 122 causes the piston of piston actuator 130 to retract and the piston of piston actuator 140 to extend. The process by which this occurs is described below.

When fluid control valve 120 is in crossover state 121, fluid flows from line 902 to line 805 through fluid control valve 120 and then to the cylinder head connection of piston actuator 140 and to fluid check valve 172. Fluid check valve 172 prevents fluid flow from line 927 to line 805; it only allows fluid to flow from line 805 to line 927. The fluid entering the cylinder head connection of piston actuator 140 forces its piston to retract into its cylinder. There are two possible cases here resulting in two different states for limit-switch valve 200.

In the first case, the piston does not retract sufficiently to apply force to mechanical activator 352 and hence does not activate limit-switch valve 200. Therefore, limit-switch valve 200 is in disconnect state 201 and fluid cannot flow from line 927 to line 806. The retraction of the piston into the cylinder of piston actuator 140 displaces fluid from the cylinder base connection of piston actuator 140 into line 806.

In the second case, the piston retracts sufficiently to apply force to mechanical activator 352 and hence activates limit-switch valve 200. Therefore, limit-switch valve 200 is in connect state 202. Fluid flows from line 805 through fluid check valve 172 and through line 927 to limit-switch valve 200. Limit-switch valve 200 is in connect state 202, so fluid flows through it into line 806 and the cylinder base connection of piston actuator 140. This fluid flow into the cylinder base connection of piston actuator 140 counteracts the piston retraction, thus preventing the piston from retracting too hard into the cylinder. This covers the two states for limit-switch valve 200.

In both cases, fluid flows from line 806 into the cylinder base connection of piston actuator 130. This fluid forces the piston of piston actuator 130 to extend from its cylinder. The piston extension forces fluid out of the cylinder head connection of piston actuator 130 into line 804. Fluid flows from line 804 to line 903 through fluid control valve 120 in crossover state 121. Line 903 returns the fluid to the fluid reservoir.

In crossover state 121, fluid loss can be seen to have occurred when the piston of piston actuator 140 is fully retracted and the piston of piston actuator 130 is not fully extended. In this situation, because the piston of piston actuator 140 is fully retracted, no more fluid can be forced out of its cylinder base connection. However, because the piston retracts sufficiently to apply force to mechanical activator 352 and hence activate limit-switch valve 200, fluid from line 805 flows successively through fluid check valve 172, line 927, limit-switch valve 200 in connect state 202, and line 806 into the cylinder base connection of piston actuator 130. This fluid flow should continue until the piston of piston actuator 130 is fully extended. Hence the circuit has compensated for fluid loss.

When fluid control valve 120 is in straight-through state 122, fluid flows from line 902 to line 804 through fluid control valve 120 and then to the cylinder head connection of piston actuator 130 and to fluid check valve 170. Fluid check valve 170 prevents fluid flow from line 907 to line 804; it only allows fluid to flow from line 804 to line 907. The fluid entering the cylinder head connection of piston actuator 130 forces its piston to retract into its cylinder. There are two possible cases here resulting in two different states for limit-switch valve 180.

In the first case, the piston does not retract sufficiently to apply force to mechanical activator 350 and hence does not activate limit-switch valve 180. Therefore, limit-switch valve 180 is in disconnect state 181 and fluid cannot flow from line 907 to line 806. The retraction of the piston into the cylinder of piston actuator 130 displaces fluid from the cylinder base connection of piston actuator 130 into line 806.

In the second case, the piston retracts sufficiently to apply force to mechanical activator 350 and hence activates limit-switch valve 180. Therefore, limit-switch valve 180 is in connect state 182. Fluid flows from line 804 through fluid check valve 170 and through line 907 to limit-switch valve 180. Limit-switch valve 180 is in connect state 182, so fluid flows through it into line 806 and the cylinder base connection of piston actuator 130. This fluid flow into the cylinder base connection of piston actuator 130 counteracts the piston retraction, thus preventing the piston from retracting too hard into the cylinder. This covers the two states for limit-switch valve 180.

In both cases, fluid flows from line 806 into the cylinder base connection of piston actuator 140. The fluid forces the piston of piston actuator 140 to extend from its cylinder. The piston extension forces fluid out of the cylinder head connection of piston actuator 140 into line 805. Fluid flows from line 805 to line 903 through fluid control valve 120 in straight-through state 122. Line 903 returns the fluid to the fluid reservoir.

In straight-through state 122, fluid loss can be seen to have occurred when the piston of piston actuator 130 is fully retracted and the piston of piston actuator 140 is not fully extended. In this situation, because the piston of piston actuator 130 is fully retracted, no more fluid can be forced out of its cylinder base connection. However, because the piston retracts sufficiently to apply force to mechanical activator 350 and hence activate limit-switch valve 180, fluid from line 804 flows successively through fluid check valve 170, line 907, limit-switch valve 180 in connect state 182, and line 806 into the cylinder base connection of piston actuator 140. This fluid flow should continue until the piston of piston actuator 140 is fully extended. Hence the circuit has compensated for fluid loss.

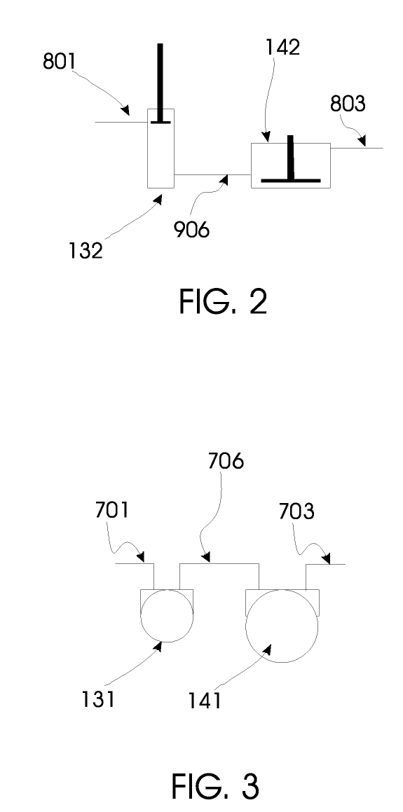

FIG. 2—Description of Linear Displacements in a Fluid Linkage Circuit with Linear Fluid Actuators

This diagram illustrates how the piston end surface area for each piston actuator affects the piston's linear displacement in the cylinder for each piston actuator when there is a fluid linkage between two piston actuators. The displacements of the pistons in each cylinder are in opposite directions. The ratio of the piston displacement in the cylinder for the first piston actuator to the piston displacement in the cylinder for the second piston actuator is equal to the ratio of the piston end surface area for the second piston actuator to the piston end surface area for the first piston actuator.

FIG. 2—Operation of Linear Displacements in a Fluid Linkage Circuit with Linear Fluid Actuators

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

Line 801 can originate from a fluid reservoir, fluid pump, fluid control valve, piston actuator, or fluid motor. Fluid is forced into line 801 and then into the cylinder head connection of piston actuator 132. This fluid forces the piston of piston actuator 132 to retract into its cylinder. This retraction forces fluid into line 906 and into the cylinder base connection of piston actuator 142. As a result, the piston of piston actuator 142 extends from its cylinder. This extension displaces fluid from the cylinder head connection of piston actuator 142 into line 803. Line 803 can go to a fluid reservoir, fluid pump, fluid control valve, piston actuator, or fluid motor.

The displacement volume of the piston in the cylinder for piston actuator 132 is equal to the displacement volume of the piston in the cylinder for piston actuator 142.
v₁₃₂=v₁₄₂

The displacement volume vis equal to the piston displacement din the cylinder multiplied by the surface area A of the piston end (top or bottom face).
V=d*A

Hence, the piston displacement d₁₃₂ in the cylinder for piston actuator 132 multiplied by the surface area A₁₃₂ of the piston end for piston actuator 132 is equal to the piston displacement d₁₄₂ in the cylinder for piston actuator 142 multiplied by the surface area A₁₄₂ of the piston end for piston actuator 142.
d₁₃₂*A₁₃₂=d₁₄₂*A₁₄₂

Therefore, the ratio of piston displacement d₁₃₂ for piston actuator 132 to piston displacement d₁₄₂ for piston actuator 142 is equal to the ratio of piston end surface area A₁₄₂ for piston actuator 142 to piston end surface area A₁₃₂ for piston actuator 132.
d₁₃₂ /d₁₄₂=A₁₄₂/A₁₃₂

FIG. 3—Description of Rotational Displacements in a Fluid Linkage Circuit with Rotary Fluid Actuators

This diagram illustrates how the rotor area of each fluid motor affects the rotor's displacement for each fluid motor when there is a fluid linkage between two fluid motors. The displacements of the rotors are in the same direction. The ratio of the rotor displacement of the first fluid motor to the rotor displacement of the second fluid motor is equal to the ratio of the rotor area for the second fluid motor to the rotor area for the first fluid motor.

FIG. 3—Operation of Rotational Displacements in a Fluid Linkage Circuit with Rotary Fluid Actuators

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the rotational displacements will still be in the same direction, but will not necessarily be of equal volume.

Line 701 can originate from a fluid reservoir, fluid pump, fluid control valve, piston actuator, or fluid motor. Fluid is forced into line 701, thereby forcing fluid motor 131 to rotate. This rotation forces the fluid out of fluid motor 131 into line 706 and then into fluid motor 141, thereby forcing fluid motor 141 to rotate. This rotation forces the fluid out of fluid motor 141 into line 703.

The displacement volume v₁₃₁ of fluid motor 131 is equal to the displacement volume v₁₄₁ of fluid motor 141.
v₁₃₁=v₁₄₁

The displacement volume vis equal to the rotational displacement d multiplied by the rotor area A.
v=d*A

Hence, the rotational displacement of d₁₃₁ of fluid motor 131 multiplied by the rotor area A₁₃₁ of fluid motor 131 is equal to the rotational displacement d₁₄₁ of fluid motor 141 multiplied by the rotor area A₁₄₁ of fluid motor 141.
d₁₃₁*A₁₃₁=d₁₄₁*A₁₄₁

Therefore, the ratio of rotational displacement d₁₃₁ for fluid motor 131 to rotational displacement d₁₄₁ for fluid motor 141 is equal to the ratio of rotor area A₁₄₁ for fluid motor 141 to rotor area A₁₃₁ for fluid motor 131.
d₁₃₁/d₁₄₁=A₁₄₁/A₁₃₁

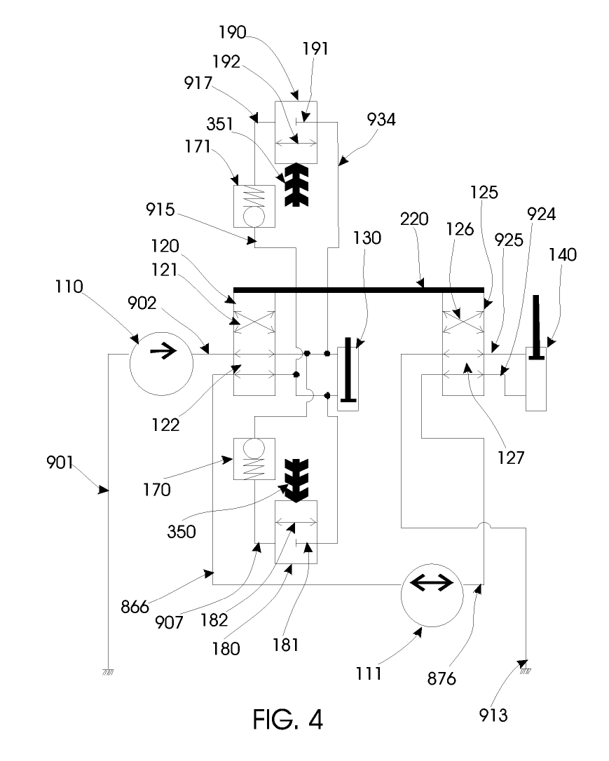

FIG. 4—Description of Fluid Linkage Circuit with Linear Fluid Actuators, a Boost Pump, and Limit-Switch Valves for Leakage Compensation, Leakage Detection, and Piston Extension/Retraction Limiting

Limit-switch valves are used for leakage compensation and piston extension/retraction limiting. There are coordinated piston displacements of equal volume but opposite direction in each cylinder because of the fluid linkage. Fluid check valves establish unidirectional fluid flow. In addition, limit-switch valves are used for leakage compensation and piston extension/retraction limiting.

FIG. 4—Operation of Fluid Linkage Circuit with Linear Fluid Actuators, a Boost Pump, and Limit-Switch Valves for Leakage Compensation, Leakage Detection, and Piston Extension/Retraction Limiting

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

Limit-switch valves can be in either a connect state or disconnect state. In the connect state, fluid flows through the valve. In the disconnect state, fluid flow through the valve is prevented. Limit-switch valves are used to compensate for fluid loss in the fluid circuit. Fluid loss occurs when there is a leak in the fluid circuit. Normally, as the piston of piston actuator 130 extends, the piston of piston actuator 140 correspondingly retracts by the same displacement volume. Similarly, as the piston of piston actuator 130 retracts, the piston of piston actuator 140 correspondingly extends by the same displacement volume. However, over time when there is fluid leakage in the fluid circuit, the piston displacement volumes will not be the same without leakage compensation.

In addition, a limit-switch valve at the cylinder head connection prevents the piston from overextending and pushing too hard against the cylinder end caps. Similarly, a limit-switch valve at the cylinder base connection prevents the piston from retracting too hard into the cylinder. This extension/retraction limiting reduces wear and tear, thus reducing the need for maintenance and increasing the lifetime of the piston actuator. The function of limit-switch valves is described below.

Fluid is drawn from the fluid reservoir by high-pressure main fluid pump 110 through line 901. Then the fluid is pumped through fluid control valve 120 by way of line 902. There are two possible states for the fluid control valve 120 and fluid control valve 125. 121 and 126 are the crossover states. 122 and 127 are the straight-through states. Fluid control valve 120 and fluid control valve 125 are mechanically synchronized by mechanical or magnetic connector 220 such that they will always simultaneously be in either the crossover state 121/126 or straight-through state 122/127.

Crossover state 121/126 of fluid control vales 120/125 causes the piston of piston actuator 130 to extend and the piston of piston actuator 140 to retract. Straight-through state 122/127 causes the piston of piston actuator 130 to retract and the piston of piston actuator 140 to extend. The process by which this occurs is described below.

When fluid control valve 120 is in crossover state 121, fluid from line 902 goes through fluid control valve 120 to line 915 and then distributed to the cylinder base connection of piston actuator 130, limit-switch valve 180 and fluid check valve 171. Fluid check valve 171 prevents fluid from flowing from line 917 to line 915; it only allows fluid to flow from line 915 to line 917. The fluid entering the cylinder base connection of piston actuator 130 forces its piston to extend. There are two possible cases here resulting in two different states for limit-switch valve 190.

In the first case, the piston does not extend sufficiently to apply force to mechanical activator 351 and hence does not activate limit-switch valve 190. Therefore, limit-switch valve 190 is in disconnect state 191 and fluid cannot flow between line 917 and line 934. The piston extension in the cylinder of piston actuator 130 displaces fluid from the cylinder head connection of piston actuator 130 into line 934.

In the second case, the piston extends sufficiently to apply force to mechanical activator 351 and hence activates limit-switch valve 190. Therefore, limit-switch valve 190 is in connect state 192. Fluid from line 915 flows through fluid check valve 171 and through line 917 to limit-switch valve 190. Limit-switch valve 190 is in connect state 192 so fluid flows through it into line 934 and the cylinder head connection of piston actuator 130. This fluid flow into the cylinder head connection of piston actuator 130 counteracts the piston extension, thus preventing the piston from overextending and pushing too hard against the cylinder end caps. This covers the two states for limit-switch valve 190.

In both cases, fluid flows from line 934 to line 866 through fluid control valve 120 in crossover state 121. Then the fluid flows to high-pressure fluid boost pump 111 via line 866. The high-pressure fluid boost pump forces fluid into line 876. Fluid flows from line 876 to line 925 through fluid control valve 125 in crossover state 126. Fluid from line 925 goes to the cylinder head connection of piston actuator 140 where it forces the piston to retract. The piston retraction forces fluid out of the cylinder base connection of piston actuator 140 into line 924. Fluid flows from line 924 to line 913 through fluid control valve 125 in crossover state 126. Line 913 returns the fluid to the fluid reservoir.

When fluid control valve 120 is in crossover state 121, the mechanically connected fluid control valve 125 is also in crossover state 126. Fluid loss can be seen to have occurred when the piston of piston actuator 130 is fully extended and the piston of piston actuator 140 is not fully retracted. In this situation, because the piston of piston actuator 130 is fully extended, no more fluid can be forced out of its cylinder head connection. However, because the piston extends sufficiently to apply force to mechanical activator 351 and hence activate limit-switch valve 190, fluid from line 915 flows successively through fluid check valve 171, line 917, limit-switch valve 190 in connect state 192, line 934, fluid control valve 120 in crossover state 121, line 866, high-pressure boost pump 111, line 876, fluid control valve 125 in crossover state 126, and line 925 into the cylinder head connection of piston actuator 140, as described above. This fluid flow should continue until the piston of piston actuator 140 is fully retracted. Hence the circuit has compensated for fluid loss.

When fluid control valve 120 is in straight-through state 122, fluid from line 902 goes through fluid control valve 120 to line 934 and then distributed to the cylinder head connection of piston actuator 130, limit-switch valve 190 and fluid check valve 170. Fluid check valve 170 prevents fluid from flowing from line 907 to line 934; it only allows fluid to flow from line 934 to line 907. The fluid entering the cylinder head connection of piston actuator 130 forces its piston to retract. There are two possible cases here resulting in two different states for limit-switch valve 180.

In the first case, the piston does not retract sufficiently to apply force to mechanical activator 350 and hence does not activate limit-switch valve 180. Therefore, limit-switch valve 180 is in disconnect state 181 and fluid cannot flow between line 907 and line 915. The piston retraction in the cylinder of piston actuator 130 displaces fluid from the cylinder base connection of piston actuator 130 into line 915.

In the second case, the piston retracts sufficiently to apply force to mechanical activator 350 and hence activates limit-switch valve 180. Therefore, limit-switch valve 180 is in connect state 182. Fluid from line 934 flows through fluid check valve 170 and through line 907 to limit-switch valve 180. Limit-switch valve 180 is in connect state 182 so fluid flows through it into line 915 and the cylinder base connection of piston actuator 130. This fluid flows into the cylinder base connection of piston actuator 130 counteracts the piston retraction, thus preventing the piston from retracting too hard into the cylinder. This covers the two states for limit-switch valve 180.

In both cases, fluid flows from line 915 to line 866 through fluid control valve 120 in straight-through state 122. Then the fluid flows to high-pressure fluid boost pump 111 via line 866. The high-pressure fluid boost pump forces fluid into line 876. Fluid flows from line 876 to line 924 through fluid control valve 125 in straight-through state 127. Fluid from line 924 goes to the cylinder base connection of piston actuator 140 where it forces the piston to extend. The piston extension forces fluid out of the cylinder head connection of piston actuator 140 into line 925. Fluid flows from line 925 to line 913 through fluid control valve 125 in straight-through state 127. Line 913 returns the fluid to the fluid reservoir.

When fluid control valve 120 is in straight-through state 122, the mechanically connected fluid control valve 125 is also in straight-through state 127. Fluid loss can be seen to have occurred when the piston of piston actuator 130 is fully retracted and the piston of piston actuator 140 is not fully extended. In this situation, because the piston of piston actuator 130 is fully retracted, no more fluid can be forced out of its cylinder head connection. However, because the piston extends sufficiently to apply force to mechanical activator 350 and hence activate limit-switch valve 180, fluid from line 934 flows successively through fluid check valve 170, line 907, limit-switch valve 180 in connect state 182, line 915, fluid control valve 120 in straight-through state 122, line 866, high-pressure boost pump 111, line 876, fluid control valve 125 in straight-through state 127, and line 924 into the cylinder base connection of piston actuator 140, as described above. This fluid flow should continue until the piston of piston actuator 140 is fully extended. Hence, the circuit has compensated for fluid loss.

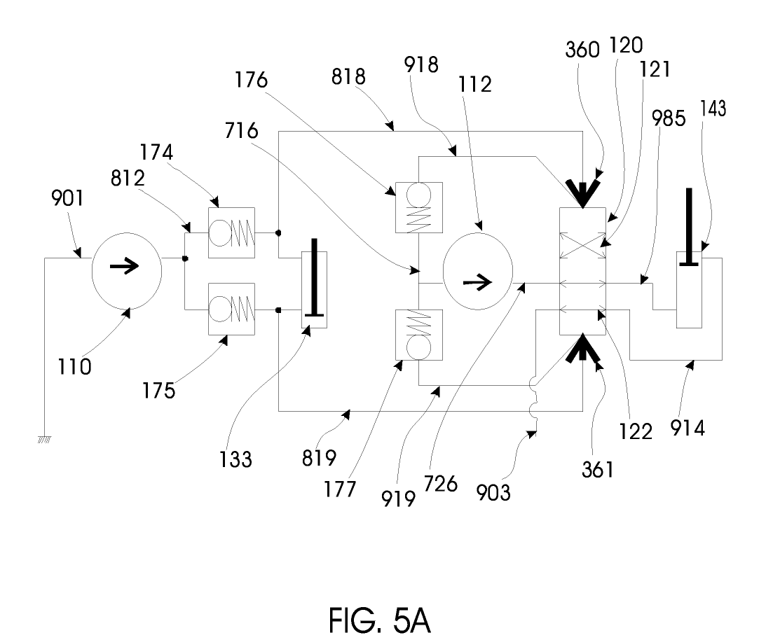

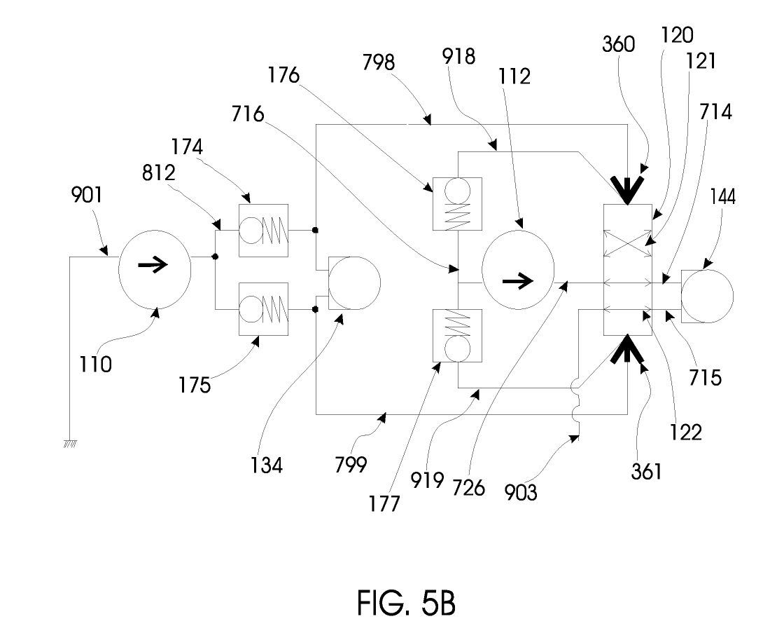

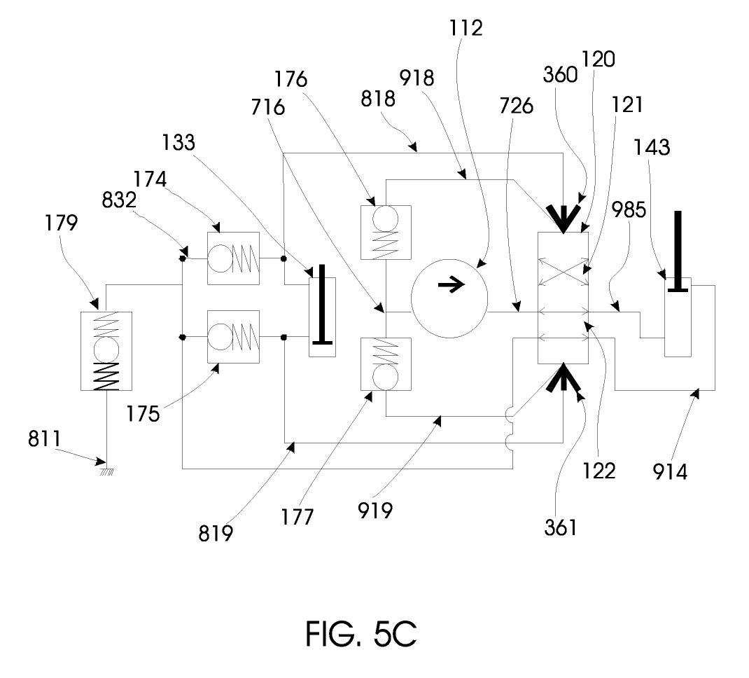

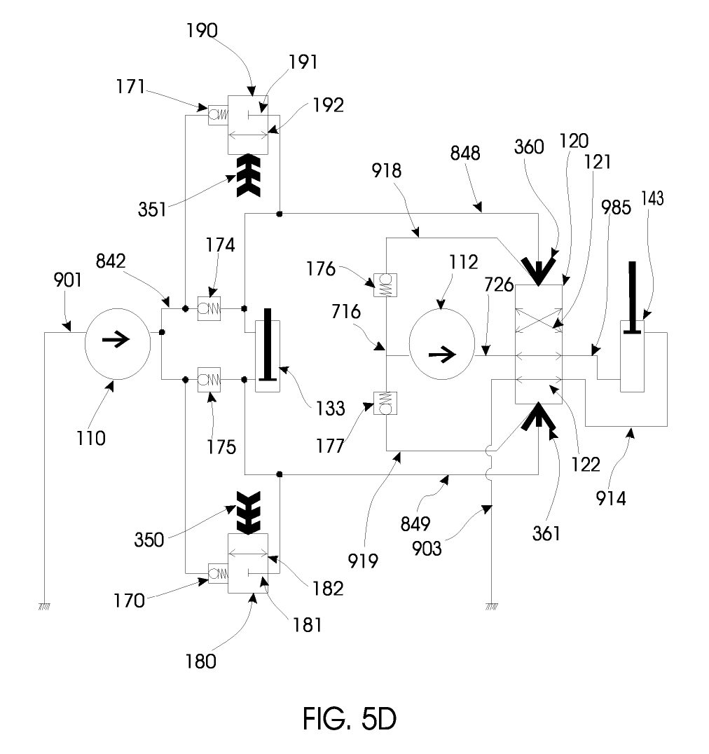

FIG. 5A—Description of Linear Actuator Servomechanism in a Fluid Linkage Circuit

The operator controls the position of the piston of the low force control piston actuator 133. This results in the piston of the drive piston actuator 143 being controlled. There are coordinated piston displacements of equal volume but opposite direction in each cylinder because of the fluid linkage.

FIG. 5A—Operation of Linear Actuator Servomechanism in a Fluid Linkage Circuit

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

If the operator extends the piston of low force control piston actuator 133, it causes the piston of drive piston actuator 143 to retract. If the operator retracts the piston of low force control piston actuator 133, it causes the piston of drive piston actuator 143 to extend. The process by which this occurs is described below.

Fluid is drawn from the fluid reservoir by high-pressure main fluid pump 110 through line 901. Fluid check valves establish unidirectional fluid flow. Fluid check valve 174 prevents fluid from flowing from line 818 to line 812; it only allows fluid to flow from line 812 to line 818. Similarly, fluid check valve 175 only allows fluid flow from line 812 to line 819, fluid check valve 176 only allows fluid flow from line 918 to line 716, and fluid check valve 177 only allows fluid flow from line 919 to line 716. There are three possible states for the piston of low force control piston actuator 133.

If the piston of low force control piston actuator 133 is stationary due to no operator movement, then high-pressure main fluid pump 110 reaches maximum pressure and does not pump fluid. There is not sufficient pressure to force fluid past fluid check valves 176 or 177 into high-pressure boost pump 112. As a result, the piston of drive piston actuator 143 is also stationary.

If the operator is extending the piston of low force control piston actuator 133, then fluid is forced through fluid check valve 175 and line 819 into the cylinder base connection of low force control piston actuator 133. The piston extension forces fluid out of the cylinder head connection of low force control piston actuator 133 into line 818. The fluid pressure in line 818 applies force to pressure activator 360, which forces fluid control valve 120 into crossover state 121. Then pressure activator 360 cannot accommodate anymore fluid. The fluid is forced by way of line 918 through fluid check valve 176 into line 716. The fluid in line 716 is drawn into high-pressure fluid boost pump 112 and forced out into line 726. In crossover state 121, fluid from line 726 goes to line 914 through fluid control valve 120 and then to the cylinder head connection of drive piston actuator 143. This fluid forces the piston to retract into the cylinder of drive piston actuator 143. This retraction displaces fluid from the cylinder base connection of drive piston actuator 143 into line 985. Line 985 is connected to line 903 through fluid control valve 120 in crossover state 121. The fluid is then returned to the fluid reservoir by way of line 903.

If the operator is retracting the piston of low force control piston actuator 133, then fluid is pumped through fluid check valve 174 and line 818 into the cylinder head connection of low force control piston actuator 133. The piston retraction forces fluid out of the cylinder base connection of low force control piston actuator 133 into line 819. The fluid pressure in line 819 applies force to pressure activator 361, which forces fluid control valve 120 into straight-through state 122. Then pressure activator 361 cannot accommodate anymore fluid. The fluid is forced by way of line 919 through fluid check valve 177 into line 716. The fluid in line 716 is drawn into high-pressure fluid boost pump 112 and forced out line 726. In straight-through state 122, fluid from line 726 goes to line 985 through fluid control valve 120 and then to the cylinder base connection of drive piston actuator 143. This fluid forces the piston to extend outside the cylinder of drive piston actuator 143. This extension displaces fluid from the cylinder head connection of drive piston actuator 143 into line 914. Line 914 is connected to line 903 through fluid control valve 120 in straight-through state 122. The fluid is then returned to the fluid reservoir by way of line 903.

FIG. 5B—Description of Rotary Actuator Servomechanism in a Fluid Linkage Circuit

The structure of the fluid circuit illustrated in FIG. 5B is the same as the fluid circuit illustrated in FIG. 5A except that linear actuators in FIG. 5B have replaced the rotary actuators in FIG. 5A.

FIG. 5B—Operation of Rotary Actuator Servomechanism in a Fluid Linkage Circuit

The operation of the fluid circuit illustrated in FIG. 5B is the same as the fluid circuit illustrated in FIG. 5A.

FIG. 5C—Description of Linear Actuator Servomechanism in a Fluid Linkage Circuit without the Low-Pressure Main Fluid Pump

FIG. 5C is similar to FIG. 5A, but reduces cost by eliminating the low-pressure fluid pump. The operator controls the position of the piston of the low force control piston actuator 133. This results in the piston of the drive piston actuator 143 being controlled. There are coordinated piston displacements of equal volume but opposite direction in each cylinder because of the fluid linkage.

FIG. 5C—Operation of Linear Actuator Servomechanism in a Fluid Linkage Circuit without the Low-Pressure Main Fluid Pump

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

Fluid check valves establish unidirectional fluid flow. Fluid check valve 174 prevents fluid from flowing from line 818 to line 832; it only allows fluid to flow from line 832 to line 818. Similarly, fluid check valve 175 only allows fluid flow from line 832 to line 819, fluid check valve 176 only allows fluid flow from line 918 to line 716, and fluid check valve 177 only allows fluid flow from line 919 to line 716. There are three possible states for the piston of low force control piston actuator 133.

If the piston of low force control piston actuator 133 is stationary due to no operator movement, then there is not sufficient pressure to force fluid past fluid check valves 176 or 177 into high-pressure boost pump 112. As a result, the piston of drive piston actuator 143 is also stationary.

If the operator extends the piston of low force control piston actuator 133, it causes the piston of drive piston actuator 143 to retract. If the operator retracts the piston of low force control piston actuator 133, it causes the piston of drive piston actuator 143 to extend. The process by which this occurs is described below.

If the operator is extending the piston of low force control piston actuator 133 then fluid is drawn from the fluid reservoir through pressure release valve 179 into line 832. Then the fluid goes through fluid check valve 175 and line 819 into the cylinder base connection of low force control piston actuator 133. The piston extension forces fluid out of the cylinder head connection of low force control piston actuator 133 into line 818. The fluid pressure in line 818 applies force to pressure activator 360, which forces fluid control valve 120 into crossover state 121. Then pressure activator 360 cannot accommodate anymore fluid. The fluid is forced by way of line 918 through fluid check valve 176 into line 716. The fluid in line 716 is drawn into high-pressure fluid boost pump 112 and forced out into line 726. In crossover state 121, fluid from line 726 goes to line 914 through fluid control valve 120 and then to the cylinder head connection of drive piston actuator 143. This fluid forces the piston to retract into the cylinder for drive piston actuator 143. This retraction displaces fluid from the cylinder base connection of drive piston actuator 143 into line 985. Line 985 is connected to line 832 through fluid control valve 120 in crossover state 121. The fluid returned to line 832 supplies some of the fluid drawn into the cylinder base connection of low force control piston actuator 133 as its piston extends. Any excess fluid in line 832 not drawn into low force control piston actuator 133 is returned to the fluid reservoir through pressure release valve 179.

If the operator is retracting the piston of low force control piston actuator 133, then fluid is drawn from the fluid reservoir through pressure release valve 179 into line 832. Then the fluid goes through fluid check valve 174 and line 818 into the cylinder head connection of low force control piston actuator 133. The piston retraction forces fluid out of the cylinder base connection of low force control piston actuator 133 into line 819. The fluid pressure in line 819 applies force to pressure activator 361, which forces fluid control valve 120 into straight-through state 122. Then pressure activator 361 cannot accommodate anymore fluid. The fluid is forced by way of line 919 through fluid check valve 177 into line 716. The fluid in line 716 is drawn into high-pressure fluid boost pump 112 and forced out line 726. In straight-through state 122, fluid from line 726 goes to line 985 through fluid control valve 120 and then to the cylinder base connection of drive piston actuator 143. This fluid forces the piston to extend outside the cylinder for drive piston actuator 143. This extension displaces fluid from the cylinder head connection of drive piston actuator 143 into line 914. Line 914 is connected to line 832 through fluid control valve 120 in straight-through state 122. The fluid returned to line 832 supplies some of the fluid drawn into the cylinder head connection of low force control piston actuator 133 as its piston retracts. Any excess fluid in line 832 not drawn into low force control piston actuator 133 is returned to the fluid reservoir through pressure release valve 179.

FIG. 5D—Description of Linear Actuator Servomechanism in a Fluid Linkage

Circuit with Limit-Switch Valves for Leakage Compensation, Leakage Location Detection, and Piston Extension/Retraction Limiting

This diagram is similar to FIG. 5A, but limit-switch valves are used to compensate and correct for fluid loss in the fluid circuit. There are coordinated piston displacements of equal volume but opposite direction in each cylinder because of the fluid linkage. Fluid check valves establish unidirectional fluid flow. In addition, limit-switch valves are used for leakage compensation and piston extension/retraction limiting.

FIG. 5D—Operation of Linear Actuator Servomechanism in a Fluid Linkage Circuit with Limit-Switch Valves for Leakage Compensation, Leakage Location Detection, and Piston Extension/Retraction Limiting

The fluid used in this circuit is incompressible with insignificant foaming characteristics, a vapor point well above expected operating temperatures, and a freezing point well below expected operating temperatures. Also, the viscosity cannot be prohibitively high; if gelling occurs, it is well below expected operating temperatures. With compressible fluids, the piston displacements will still be in opposite directions in each cylinder, but the piston displacements will not necessarily be of equal volume in each cylinder.

Limit-switch valves can be in either a connect state or disconnect state. In the connect state, fluid flows through the valve. In the disconnect state, fluid flow through the valve is prevented. Limit-switch valves are used to compensate for fluid loss in the fluid circuit. Fluid loss occurs when there is a leak in the fluid circuit. Normally, as the piston of piston actuator 133 extends, the piston of piston actuator 143 correspondingly retracts by the same displacement volume. Similarly, as the piston of piston actuator 133 retracts, the piston of piston actuator 143 correspondingly extends by the same displacement volume. However, over time, when there is fluid leakage in the fluid circuit, the piston displacement volumes will not be the same without leakage compensation.

In addition, a limit-switch valve at the cylinder head connection prevents the piston from overextending and pushing too hard against the cylinder end caps. Similarly, a limit-switch valve at the cylinder base connection prevents the piston from retracting too hard into the cylinder. This extension/retraction limiting reduces wear and tear, thus reducing the need for maintenance and increasing the lifetime of the piston actuator. The function of limit-switch valves is described below.

Fluid is drawn from the fluid reservoir by low-pressure main fluid pump 110 through line 901. Fluid check valves establish unidirectional fluid flow. Fluid check valve 174 prevents fluid from flowing from line 848 to line 842; it only allows fluid to flow from line 842 to line 848. Similarly, fluid check valve 175 only allows fluid flow from line 842 to line 849, fluid check valve 176 only allows fluid flow from line 918 to line 716, and fluid check valve 177 only allows fluid flow from line 919 to line 716. There are three possible states for the piston of low force control piston actuator 133.

If the piston of low force control piston actuator 133 is stationary due to no operator movement, then low-pressure main fluid pump 110 reaches maximum pressure and does not pump fluid. There is not sufficient pressure to force fluid passed fluid check valves 176 or 177 into high-pressure boost pump 112. As a result, the piston of drive piston actuator 143 is also stationary.

If the operator is extending the piston of low force control piston actuator 133, and the piston does not extend sufficiently to apply force to mechanical activator 351, then limit-switch valve 190 is not activated. Therefore, limit-switch valve 190 is in disconnect state 191 and fluid cannot flow between line 842 and line 848. The extension of low force control piston actuator 133 allows the pump 110 to force fluid through fluid check valve 175 and line 849 into the cylinder base connection of low force control piston actuator 133. The piston extension forces fluid out of the cylinder head connection of low force control piston actuator 133 into line 848. The fluid pressure in line 848 applies force to pressure activator 360, which forces fluid control valve 120 into crossover state 121. When pressure activator 360 cannot accommodate anymore fluid, the fluid is forced by way of line 918 through fluid check valve 176 into line 716. The fluid in line 716 is drawn into high-pressure fluid boost pump 112 and forced out into line 726. In crossover state 121, fluid from line 726 goes to line 914 through fluid control valve 120 and then to the cylinder head connection of drive piston actuator 143. This fluid forces the piston to retract into the cylinder of drive piston actuator 143. This retraction displaces fluid from the cylinder base connection of drive piston actuator 143 into line 985. Line 985 is connected to line 903 through fluid control valve 120 in crossover state 121. The fluid is then returned to the fluid reservoir by way of line 903.

If the operator is extending the piston of low force control piston actuator 133, and the piston extends sufficiently to apply force to mechanical activator 351, then limit-switch valve 190 is activated. Therefore, limit-switch valve 190 is in connect state 192. Fluid check valve 171 prevents fluid from flowing from line 848 to line 842; it only allows fluid to flow from line 842 to line 848. The check valve 171 and limit-switch 190 are designed to reduce the fluid pressure less than the check valves 174 and 175. As a result the fluid pressure in line 848 is greater than in line 849. The fluid pressure in line 848 applies force to pressure activator 360, which forces fluid control valve 120 into crossover state 121. When pressure activator 360 cannot accommodate anymore fluid, the fluid is forced by way of line 918 through fluid check valve 176 into line 716. The fluid in line 716 is drawn into high-pressure fluid boost pump 112 and forced out into line 726. In crossover state 121, fluid from line 726 goes to line 914 through fluid control valve 120 and then to the cylinder head connection of drive piston actuator 143. This fluid forces the piston to retract into the cylinder of drive piston actuator 143. This retraction displaces fluid from the cylinder base connection of drive piston actuator 143 into line 985. Line 985 is connected to line 903 through fluid control valve 120 in crossover state 121. The fluid is then returned to the fluid reservoir by way of line 903. This covers the two states for limit-switch valve 190.

If the operator is retracting the piston of low force control piston actuator 133, and the piston does not retract sufficiently to apply force to mechanical activator 350, then limit-switch valve 180 is not activated. Therefore, limit-switch valve 180 is in disconnect state 181 and fluid cannot flow between line 842 and line 849. The retraction of low force control piston actuator 133 allows the pump 110 to force fluid through fluid check valve 174 and line 848 into the cylinder head connection of low force control piston actuator 133. The piston retraction forces fluid out of the cylinder base connection of low force control piston actuator 133 into line 849. The fluid pressure in line 849 applies force to pressure activator 361, which forces fluid control valve 120 into straight-through state 122. When pressure activator 361 cannot accommodate anymore fluid, the fluid is forced by way of line 919 through fluid check valve 177 into line 716. The fluid in line 716 is drawn into high-pressure fluid boost pump 112 and forced out into line 726. In straight-through state 122, fluid from line 726 goes to line 985 through fluid control valve 120 and then to the cylinder base connection of drive piston actuator 143. This fluid forces the piston to extend out of the cylinder of drive piston actuator 143. This extension displaces fluid from the cylinder head connection of drive piston actuator 143 into line 914. Line 914 is connected to line 903 through fluid control valve 120 in straight-through state 122. The fluid is then returned to the fluid reservoir by way of line 903.

If the operator is retracting the piston of low force control piston actuator 133, and the piston retracts sufficiently to apply force to mechanical activator 350, then limit-switch valve 180 is activated. Therefore, limit-switch valve 180 is in connect state 182. Fluid check valve 170 prevents fluid from flowing from line 849 to line 842; it only allows fluid to flow from line 842 to line 849. The check valve 170 and limit-switch 180 are designed to reduce the fluid pressure less then the check vales 174 and 175. As a result, the fluid pressure in line 849 is greater then in line 848. The fluid pressure in line 849 applies force to pressure activator 361, which forces fluid control valve 120 into straight-through state 122. When pressure activator 361 cannot accommodate anymore fluid, the fluid is forced by way of line 919 through fluid check valve 177 into line 716. The fluid in line 716 is drawn into high-pressure fluid boost pump 112 and forced out into line 726. In straight-through state 122, fluid from line 726 goes to line 985 through fluid control valve 120 and then to the cylinder base connection of drive piston actuator 143. This fluid forces the piston to extend out of the cylinder of drive piston actuator 143. This extension displaces fluid from the cylinder head connection of drive piston actuator 143 into line 914. Line 914 is connected to line 903 through fluid control valve 120 in straight-through state 122. The fluid is then returned to the fluid reservoir by way of line 903. This covers the two states for limit-switch valve 180.

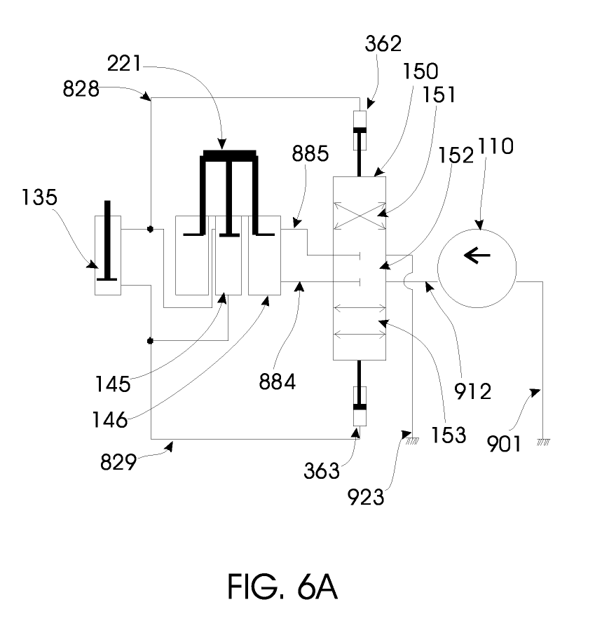

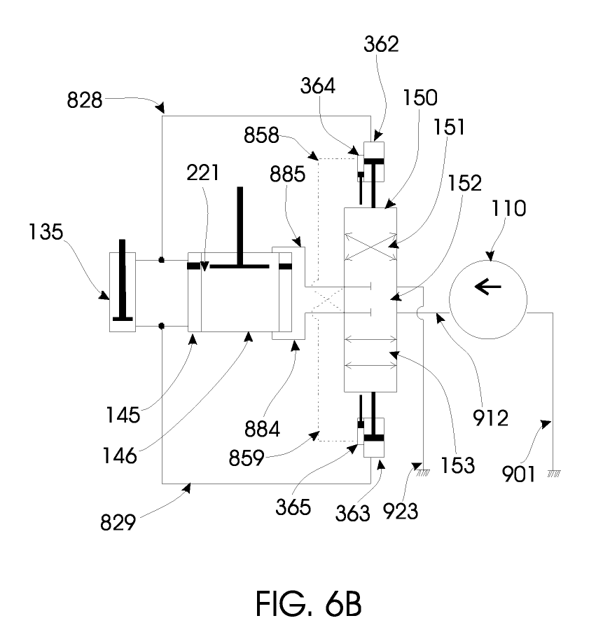

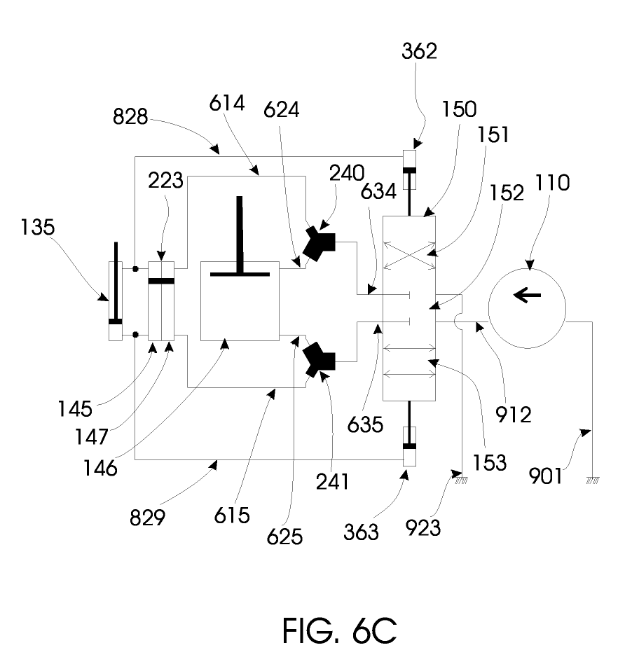

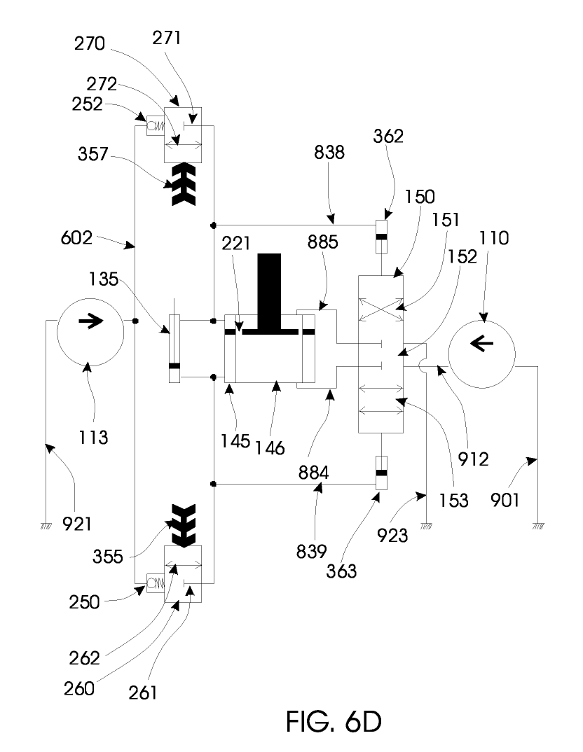

FIG. 6A—Description of Servomechanism Fluid Valve in a Fluid Linkage Circuit

The operator controls the position of the piston of the control piston actuator 135. This results in the piston of the feedback piston actuator 145 being controlled. The piston rod of drive piston actuator 146 and the piston rod of feedback piston actuator 145 are attached by mechanical or magnetic connection 221. The piston of the drive piston actuator 146 provides assistance in moving the piston of the feedback piston actuator 145. This functions as a power assist.

FIG. 6A—Operation of Servomechanism Fluid Valve in a Fluid Linkage Circuit

If the piston of control piston actuator 135 is stationary due to no operator movement, then the fluid pressure in line 828 and line 829 is equal. As a result, the pressure activated fluid control valve will return to the disconnect state 152. In disconnect state 152, fluid is neither pumped into nor drained from drive piston actuator 146. As a result, the piston of drive piston actuator 146 is stationary.

If the operator is extending the piston of control piston actuator 135, then fluid is forced out of the cylinder head connection of control piston actuator 135 through line 828 into the cylinder head connection of feedback piston actuator 145. Fluid is drawn from the cylinder base connection of feedback piston actuator 145 through line 829 into the cylinder base connection of control piston actuator 135. These two actions will apply a retraction force on the piston of feedback piston actuator 145. This retraction force is proportional to the pressure difference between line 828 and line 829 where line 828 has a greater pressure. If the pressure difference between line 828 and line 829 is greater than the activation threshold, then the greater pressure in line 828 than in line 829 will apply force to pressure activator 362. This forces fluid control valve 150 into the crossover state 151.

Fluid is drawn from the fluid reservoir by high-pressure main fluid pump 110 through line 901. Then the fluid is pumped through fluid control valve 150 by way of line 912. In crossover state 151, fluid goes from line 912 through fluid control valve 150 to line 885 and then into the cylinder head connection of drive piston actuator 146. This forces the piston of drive piston actuator 146 to retract. This piston retraction forces fluid out of the cylinder base connection of drive piston actuator 146 into line 884. In crossover state 151, fluid from line 884 goes through fluid control valve 150 to line 923 and then drains into the fluid reservoir. When the piston of drive piston actuator 146 retracts, it simultaneously causes the piston of feedback piston actuator 145 to retract because the mechanical or magnetic connection 221 attaches both pistons. The piston retraction of feedback piston actuator 145 draws fluid into the cylinder head connection of drive piston actuator 145, thereby reducing the pressure in line 828. Fluid is simultaneously forced out of the cylinder base connection of feedback piston actuator 145 into line 829, thereby increasing the pressure in line 829. As a result, the pressure difference between line 828 and line 829 decreases. When the pressure difference between line 828 and line 829 falls below the activation threshold, there is insufficient force applied to pressure activator 362 to keep fluid control valve 150 in crossover state 151. Therefore, it reverts back to disconnect state 152.

If the operator is retracting the piston of control piston actuator 135, then fluid is forced out of the cylinder base connection of control piston actuator 135 through line 829 into the cylinder base connection of feedback piston actuator 145. Fluid is drawn from the cylinder head connection of feedback piston actuator 145 through line 828 into the cylinder head connection of control piston actuator 135. These two actions will apply an extension force on the piston of feedback piston actuator 145. This extension force is proportional to the pressure difference between line 829 and line 828 where line 829 has a greater pressure. If the pressure difference between line 829 and line 828 is greater than the activation threshold, then the greater pressure in line 829 than in line 828 will apply force to pressure activator 363. This forces fluid control valve 150 into the straight-through state 153.

Fluid is drawn from the fluid reservoir by high-pressure main fluid pump 110 through line 901. Then the fluid is pumped through fluid control valve 150 by way of line 912. In straight-through state 153, fluid goes from line 912 through fluid control valve 150 to line 884 and then into the cylinder base connection of drive piston actuator 146. This forces the piston of drive piston actuator 146 to extend. This piston extension forces fluid out of the cylinder head connection of drive piston actuator 146 into line 885. In straight-through state 153, fluid from line 885 goes through fluid control valve 150 to line 923 and then drains into the fluid reservoir. When the piston of drive piston actuator 146 extends, it simultaneously causes the piston of feedback piston actuator 145 to extend because the mechanical or magnetic connection 221 attaches both pistons. The piston extension of feedback piston actuator 145 draws fluid into the cylinder base connection of drive piston actuator 146, thereby reducing the pressure in line 829. Fluid is simultaneously forced out of the cylinder head connection of drive piston actuator 146 into line 828, thereby increasing the pressure in line 828. As a result, the pressure difference between line 829 and line 828 decreases. When the pressure difference between line 829 and line 828 falls below the activation threshold, there is insufficient force applied to pressure activator 363 to keep fluid control valve 150 in straight-through state 153. Therefore, it reverts back to disconnect state 152.

FIG. 6B—Description of Servomechanism Fluid Valve in a Fluid Linkage Circuit Using Feedback Linkage between Control Piston Actuator and Drive Actuator

The operation of this fluid circuit is almost exactly the same as the previous cross connect fluid valve control circuit shown in FIG. 6A. However, this circuit diagram illustrates an alternative method of attaching the feedback piston actuator 145 to the drive piston actuator 146 and illustrates one possible embodiment of pressure activators 362 and 363. In the circuit diagram, the feedback piston actuator 145 completely encircles the drive piston actuator 146. Alternatively, the drive piston actuator 146 could completely encircle the feedback piston actuator 145. The drive piston actuator 146 and feedback piston actuator 145 are attached through mechanical or magnetic connection 221. Addition tactile feedback pressure actuators 364, 365 are added to enable the operator to feel a resisting force on the control piston actuator 135 proportional to the servomotor load.

FIG. 6B—Operation of Servomechanism Fluid Valve in a Fluid Linkage Circuit Using Feedback Linkage between Control Piston Actuator and Drive Actuator

For operation of this circuit, see FIG. 6A. The operation of tactile feedback pressure actuators is described below. The pilot line 858 connects the output of fluid control valve 150 to the head of the tactile feedback pressure actuator 364. This pilot line connection is equivalent to connecting the base of drive piston actuator 146 to the head of tactile feedback pressure actuator 364. The force applied by the tactile feedback pressure actuator 364 resists the pressure activator 363 moving the fluid control valve 150 from the neutral state into the straight-through state 153. In turn, the increased pressure in line 828 required to overcome the apposing force of the tactile feedback pressure actuator 364, is felt by the operator as an increased force required to extend the control piston actuator 135. As a result the operator can feel a load when extending the control piston actuator 135 proportional to the force required to retract the drive piston actuator 146.

The pilot line 859 connects the output of fluid control valve 150 to the head of the tactile feedback pressure actuator 365. This pilot line connection is equivalent to connecting the head of drive piston actuator 146 to the head of tactile feedback pressure actuator 365. The force applied by the tactile feedback pressure actuator 365 resists the pressure activator 362 moving the fluid control valve 150 from the neutral state into the crossover state 151. In turn the increased pressure in line 829 required to overcome the apposing force of the tactile feedback pressure actuator 365, is felt by the operator as an increased force required to retract the control piston actuator 135. As a result the operator can feel a load when retracting the control piston actuator 135 proportional to the force required to extend the drive piston actuator 146.

The tactile feedback pressure actuators 364 applies a force against the pressure activator 363 moving the fluid control valve 150 from the neutral state 152 into the straight-through state 153. The tactile feedback pressure actuators 365 applies a force against the pressure activator 362 moving the fluid control valve 150 from the neutral state 152 into the crossover state 151. When the fluid control valve 150 is in the neutral state 152, the tactile feedback pressure actuators 364 and 365 are fully extended. In order to feel the load currently on the drive piston actuator 146, the operator must be in the process of trying to extend or retract it. This is a safety feature allowing the operator to release the control piston actuator 135 without worrying about the drive piston actuator 146 moving.

FIG. 6C—Description of Servomechanism Fluid Valve in a Fluid Linkage Circuit Using a Drive Piston Actuator Supplied by Fluid Flow Splitters

The operation of this circuit is similar to the previous circuit shown in FIG. 6A. The operator controls the position of the piston in the control piston actuator 135. This results in the piston in the feedback piston actuator 145 being controlled. The feedback piston actuator 145 is mechanically or magnetically linked to the split drive piston actuator 147. The piston in split drive piston actuator 147 provides assistance in moving the piston in the feedback piston actuator 145. The positions of the split drive piston actuator 147 and the drive piston actuator 146 are correlated by means of the fluid flow splitters 240 and 241. This functions as a power assist.

The ratio of the displacements of the pistons in each cylinder is equal to the ratio of the opposite piston surface areas. The piston displacements in each cylinder are in opposite directions. The displacement volume of cylinder 135 is equal to the displacement volume of cylinder 145. The displacement volume is equal to the displacement of the piston in the cylinder multiplied by the piston surface area. Hence, the displacement in cylinder 135 multiplied by the piston surface area in cylinder 135 is equal to the displacement in cylinder 145 multiplied by the piston surface area in cylinder 145. Therefore, the ratio of displacement in cylinder 135 to displacement in cylinder 145 is equal to the ratio of piston surface area in cylinder 145 to piston surface area in cylinder 135.

FIG. 6C—Operation of Servomechanism Fluid Valve in a Fluid Linkage Circuit Using a Drive Piston Actuator Supplied by Fluid Flow Splitters

Fluid is drawn from the fluid reservoir through line 901 by high-pressure main fluid pump 110. Then the fluid is pumped through fluid control valve 150 by way of line 912. There are three possible states for the control piston, which is controlled by an operator.

If control piston 135 is stationary due to no operator movement, then the fluid pressure in line 828 and line 829 are equal. As a result, the pressure activated fluid control valve 150 will return to the disconnect state 152. In disconnect state 152, fluid is neither pumped into nor drained from drive piston actuator 146. As a result, the piston of drive piston actuator 146 is stationary.

If the operator is extending control piston 135, then fluid is forced out of the cylinder head connection of control piston actuator 135 through line 828 into the cylinder head connection of feedback piston actuator 145. Fluid is drawn from the cylinder base connection of feedback piston actuator 145 through line 829 into the cylinder base connection of control piston actuator 135. These two actions will apply a retraction force on the piston of feedback piston actuator 145. This retraction force is proportional to the pressure difference between line 828 and line 829 where line 828 is at a greater pressure. If the pressure difference between line 828 and line 829 is greater than the activation threshold, then the greater pressure in line 828 than in line 829 will apply force to pressure activator 362. This forces fluid control valve 150 into the crossover state 151. In the crossover state 151, the high-pressure main fluid pump 110 draws fluid from the fluid reservoir via line 901. The pump forces the fluid out line 912 which is connected to line 634 in crossover state 151. Fluid from line 634 is forced into fluid flow splitter to piston actuator 240. The fluid flow splitter 240 divides the fluid flow between its two outlet ports. Fluid forced out one outlet port flows into the cylinder head connection of drive piston actuator 146 via line 624. Similarly fluid forced out the other outlet port flows into the cylinder head connection of the split drive piston actuator 147 via line 614. Ideally the ration of the two fluid flows would be constant and not change over time. In this case the piston position of the drive piston actuator 146 could be implied by the piston position of the split drive piston actuator 147. This fluid forces the piston in drive piston actuator 146 and the piston in split drive piston actuator 147 to retract. The retraction of the drive piston forces fluid out of the cylinder base connection of drive piston actuator 146 into line 625. The retraction of the split drive piston forces fluid out of the cylinder base connection of split drive piston actuator 147 into line 615. Fluid from line 615 and 625 flows through the fluid flow splitter 241 into line 635. Fluid from line 635 goes to line 923 via the crossover connection in state 151 and then drains into the fluid reservoir. When the piston in split drive piston actuator 147 retracts, it simultaneously retracts the piston in feedback piston actuator 145 because the mechanical/magnetic connector 223 connects both pistons. The retraction of the piston in feedback piston actuator 145 draws fluid into the cylinder head connection of feedback piston actuator 145, thereby reducing the pressure in line 828. At the same time, fluid is forced out of the cylinder base connection of feedback piston actuator 145 into line 829, thereby increasing the pressure in line 829. As a result, the pressure difference between line 828 and line 829 decreases. When the pressure difference between line 828 and line 829 falls below the activation threshold, there is insufficient force applied to pressure activator 362 to keep fluid control valve 150 in crossover state 151. Therefore, it reverts back to disconnect state 152.

If the operator is retracting control piston 135, then fluid is forced out of the cylinder base connection of control piston actuator 135 through line 829 into the cylinder base connection of feedback piston actuator 145. Fluid is drawn from the cylinder head connection of feedback piston actuator 145 through line 828 into the cylinder head connection of control piston actuator 135. These two actions will apply an extension force on the piston of feedback piston actuator 145. This extension force is proportional to the pressure difference between line 828 and line 829 where line 829 is at a greater pressure. If the pressure difference between line 828 and line 829 is greater than the activation threshold, then the greater pressure in line 829 than in line 828 will apply force to pressure activator 363. This forces fluid control valve 150 into the crossover state 153. In the straight-through state 153, the high-pressure main fluid pump 110 draws fluid from the fluid reservoir via line 901. The pump forces the fluid out line 912 which is connected to line 635 in straight-through state 153. Fluid from line 635 is forced into fluid flow splitter to piston actuator 241. The fluid flow splitter 241 divides the fluid flow between its two outlet ports. Fluid forced out one outlet port flows into the cylinder base connection of drive piston actuator 146 via line 625. Similarly fluid forced out the other outlet port flows into the cylinder base connection of the split drive piston actuator 147 via line 615. Ideally, the ration of the two fluid flows would be constant and not change over time. In this case the piston position of the drive piston actuator 146 could be implied by the piston position of the split drive piston actuator 147. This fluid forces the piston in drive piston actuator 146 and the piston in split drive piston actuator 147 to extend. The extension of the drive piston forces fluid out of the cylinder head connection of drive piston actuator 146 into line 624. The extension of the split drive piston forces fluid out of the cylinder head connection of split drive piston actuator 147 into line 614. Fluid from line 614 and 624 flows through the fluid flow splitter 240 into line 634. Fluid from line 634 goes to line 923 via the straight-through connection in state 153 and then drains into the fluid reservoir. When the piston in split drive piston actuator 147 extends, it simultaneously extends the piston in feedback piston actuator 145 because the mechanical/magnetic connector 223 connects both pistons. This extension of the piston in feedback piston actuator 145 draws fluid into the cylinder base connection of feedback piston actuator 145, thereby reducing the pressure in line 829. At the same time, fluid is forced out of the cylinder head connection of split drive piston actuator 147 into line 828, thereby increasing the pressure in line 828. As a result, the pressure difference between line 828 and line 829 decreases. When the pressure difference between line 828 and line 829 falls below the activation threshold, there is insufficient force applied to pressure activator 363 to keep fluid control valve 150 in straight-through state 153. Therefore, it reverts back to disconnect state 152.

FIG. 6D—Description of Servomechanism Fluid Valve in a Fluid Linkage Circuit with Limit-Switch Valves for Leakage Compensation, Leakage Detection, and Piston Extension/Retraction Limiting

This diagram is similar to FIG. 6A where additional limit-switch valves are used to compensate for fluid loss in the fluid circuit. The operator controls the position of the piston in the control piston actuator. This results in the piston in the feedback piston actuator being controlled. The piston in the drive piston actuator provides assistance in moving the piston in the feedback piston actuator. This functions as a power assist.

The ratio of the displacements of the pistons in each cylinder is equal to the ratio of the opposite piston surface areas. The piston displacements in each cylinder are in opposite directions. The displacement volume of cylinder 135 is equal to the displacement volume of cylinder 145. The displacement volume is equal to the displacement of the piston in the cylinder multiplied by the piston surface area. Hence, the displacement in cylinder 135 multiplied by the piston surface area in cylinder 135 is equal to the displacement in cylinder 145 multiplied by the piston surface area in cylinder 145. Therefore, the ratio of displacement in cylinder 135 to displacement in cylinder 145 is equal to the ratio of piston surface area in cylinder 145 to piston surface area in cylinder 135.

FIG. 6D—Operation of Servomechanism Fluid Valve in a Fluid Linkage Circuit with Limit-Switch Valves for Leakage Compensation, Leakage Detection, and Piston Extension/Retraction Limiting

Fluid is drawn from the fluid reservoir through line 901 by high-pressure main fluid pump 110. Then the fluid is pumped through fluid control valve 150 by way of line 912.

If control piston 135 is stationary due to no operator movement, then the fluid pressure in line 838 and line 839 are equal. As a result, the pressure activated fluid control valve will return to the disconnect state 152. In disconnect state 152, fluid is neither pumped into nor drained from drive piston actuator 146. As a result, the piston of drive piston actuator 146 is stationary.

However, fluid loss can be detected when the control piston actuator 135 is fully extended and the feedback piston actuator 145 is not fully retracted. In this situation, limit-switch valve 270 allows fluid to flow into the cylinder head connection of feedback piston actuator 145 until the feedback piston actuator 145 is fully retracted. At this point, the control piston actuator 135 is fully extended and the feedback piston actuator 145 is fully retracted. The circuit has compensated for fluid loss.

Fluid loss can also be detected when the control piston actuator 135 is fully retracted and the feedback piston actuator 145 is not fully extended. In this situation, limit-switch valve 260 allows fluid to flow into the cylinder base connection of feedback piston actuator 145 until the feedback piston actuator 145 is fully extended. At this point, the control piston actuator 135 is fully retracted and the feedback piston actuator 145 is fully extended. The circuit has compensated for fluid loss.

If the operator is extending control piston 135, then fluid is forced out of the cylinder head connection of control piston actuator 135 through line 838 into the cylinder head connection of feedback piston actuator 145. Fluid is drawn from the cylinder base connection of feedback piston actuator 145 through line 839 into the cylinder base connection of control piston actuator 135. These two actions will apply a retraction force on the piston of feedback piston actuator 145. There are two possible cases here resulting in two different states for limit-switch valve 270.

In the first case, the control piston actuator 135 has not extended sufficiently to apply force to mechanical activator 357 and hence does not activate limit-switch valve 270. Therefore, limit-switch valve 270 is in the disconnect state 271.

This retraction force is proportional to the pressure difference between line 838 and line 839 where line 838 is at a greater pressure. If the pressure difference between line 838 and line 839 is greater than the activation threshold, then the greater pressure in line 838 than in line 839 will apply force to pressure activator 362. This forces fluid control valve 150 into the crossover state 151. In crossover state 151, the high-pressure main fluid pump 110 draws fluid from the fluid reservoir via line 901. The main pump forces the fluid out line 912 which is connected to line 885 in crossover state 151. Fluid from line 885 is forced into the cylinder head connection of drive piston actuator 146. This forces the piston in drive piston actuator 146 to retract. This retraction of the piston forces fluid out of the cylinder base connection of drive piston actuator 146 into line 884. Fluid from line 884 goes to line 923 via the crossover connection in state 151 and then drains into the fluid reservoir. When the piston in drive piston actuator 146 retracts, it simultaneously retracts the piston in feedback piston actuator 145 because the mechanical connector 221 connects both pistons. The retraction of the piston in feedback piston actuator 145 draws fluid into the cylinder head connection of feedback piston actuator 145, thereby reducing the pressure in line 838. At the same time, fluid is forced out of the cylinder base connection of feedback piston actuator 145 into line 839, thereby increasing the pressure in line 839. As a result, the pressure difference between line 838 and line 839 decreases. When the pressure difference between line 838 and line 839 falls below the activation threshold, there is insufficient force applied to pressure activator 362 to keep fluid control valve 150 in crossover state 151. Therefore, it reverts back to disconnect state 152.

In the second case, the control piston actuator 135 has extended sufficiently to apply force to mechanical activator 357 and hence activates limit-switch valve 270. Therefore, limit-switch valve 270 is in the connect state 272. The control circuit fluid pump draws fluid from a fluid reservoir via line 921. The control circuit fluid pump forces the fluid out line 602 which is connected to the fluid check valves 250, and 252. Fluid from line 602 flows through fluid check valve 252 into the limit-switch valve 270. Limit-switch valve 270 is in connect state 272 so fluid flows through it into line 838, thereby increasing the pressure in line 838. The greater pressure in line 838 than in line 839 will apply force to pressure activator 362. This forces fluid control valve 150 into the crossover state 151. In crossover state 151, the high-pressure main fluid pump 110 draws fluid from the fluid reservoir via line 901. The main pump forces the fluid out line 912 which is connected to line 885 in crossover state 151. Fluid from line 885 is forced into the cylinder head connection of drive piston actuator 146. This forces the piston in drive piston actuator 146 to retract. This retraction of the piston forces fluid out of the cylinder base connection of drive piston actuator 146 into line 884. Fluid from line 884 goes to line 923 via the crossover connection in state 151 and then drains into the fluid reservoir. When the piston in drive piston actuator 146 retracts, it simultaneously retracts the piston in feedback piston actuator 145 because the mechanical connector 221 connects both pistons. The pressure difference between line 838 and line 839 falls below the activation threshold, there is insufficient force applied to pressure activator 362 to keep fluid control valve 150 in crossover state 151. Therefore, it reverts back to disconnect state 152.

The above covers the case for limit-switch valve 270.

If the operator is retracting control piston 135, then fluid is forced out of the cylinder base connection of control piston actuator 135 through line 839 into the cylinder base connection of feedback piston actuator 145. Fluid is drawn from the cylinder head connection of feedback piston actuator 145 through line 838 into the cylinder head connection of control piston actuator 135. These two actions will apply an extension force on the piston of feedback piston actuator 145. There are two possible cases here resulting in two different states for limit-switch valve 260.

In the first case, the control piston actuator 135 has not retracted sufficiently to apply force to mechanical activator 355 and hence does not activate limit-switch valve 260. Therefore, limit-switch valve 260 is in the disconnect state 261.

This extension force is proportional to the pressure difference between line 838 and line 839 where line 839 is at a greater pressure. If the pressure difference between line 838 and line 839 is greater than the activation threshold, then the greater pressure in line 839 than in line 838 will apply force to pressure activator 363. This forces fluid control valve 150 into the straight-through state 153. In straight-through state 153, the high-pressure main fluid pump 110 draws fluid from the fluid reservoir via line 901. The main pump forces the fluid out line 912 which is connected to line 884 in straight-through state 153. Fluid from line 884 is forced into the cylinder base connection of drive piston actuator 146. This forces the piston in drive piston actuator 146 to extend. This extension of the piston forces fluid out of the cylinder head connection of drive piston actuator 146 into line 885. Fluid from line 885 goes to line 923 via the straight-through connection in state 153 and then drains into the fluid reservoir. When the piston in drive piston actuator 146 extends, it simultaneously extends the piston in feedback piston actuator 145 because the mechanical or magnetic connector 221 connects both pistons. The extension of the piston in feedback piston actuator 145 draws fluid into the cylinder base connection of feedback piston actuator 145, thereby reducing the pressure in line 839. At the same time, fluid is forced out of the cylinder head connection of feedback piston actuator 145 into line 838, thereby increasing the pressure in line 838. As a result, the pressure difference between line 838 and line 839 decreases. When the pressure difference between line 838 and line 839 falls below the activation threshold, there is insufficient force applied to pressure activator 363 to keep fluid control valve 150 in straight-through state 153. Therefore, it reverts back to disconnect state 152.

In the second case, the control piston actuator 135 has retracted sufficiently to apply force to mechanical activator 355 and hence activates limit-switch valve 260. Therefore, limit-switch valve 260 is in the connect state 262. The control circuit fluid pump draws fluid from a fluid reservoir via line 921. The control circuit fluid pump forces the fluid out line 602 which is connected to the fluid check valves 250, and 252. Fluid from line 602 flows through fluid check valve 250 into the limit-switch valve 260. Limit-switch valve 260 is in connect state 262 so fluid flows through it into line 839. Thereby increasing the pressure in line 839, the greater pressure in line 839 than in line 838 will apply force to pressure activator 363. This forces fluid control valve 150 into the straight-through state 153. In straight-through state 153, the high-pressure main fluid pump 110 draws fluid from the fluid reservoir via line 901. The main pump forces the fluid out line 912 which is connected to line 884 in straight-through state 153. Fluid from line 884 is forced into the cylinder base connection of drive piston actuator 146. This forces the piston in drive piston actuator 146 to extend. This extension of the piston forces fluid out of the cylinder head connection of drive piston actuator 146 into line 885. Fluid from line 885 goes to line 923 via the straight-through connection in state 153 and then drains into the fluid reservoir. When the piston in drive piston actuator 146 extends, it simultaneously extends the piston in feedback piston actuator 145 because the mechanical/magnetic connector 221 connects both pistons. The pressure difference between line 838 and line 839 falls below the activation threshold, there is insufficient force applied to pressure activator 363 to keep fluid control valve 150 in straight-through state 153. Therefore, it reverts back to disconnect state 152.

The above covers the case for limit-switch valve 260.

### CONCLUSION, RAMIFICATIONS, AND SCOPE

Accordingly, the reader will see that the fluid linkage of this invention links piston actuators or fluid motors together through a hydraulic or pneumatic circuit such that the parts move in a coordinated manner. Fluid displaced by piston actuator or fluid motor movement is supplied to other piston actuators or fluid motors, so they move by a corresponding amount. This is extremely useful in self-leveling, steering linkage replacement, aerodynamic control surface servomechanisms, and many more applications. Through the use of limit-switch valves, the fluid linkage can include leakage compensation and leakage location detection and allow for accurate control over the extension and retraction of a piston in the piston actuator. To fully understand the advantages of a fluid linkage, some existing systems that could benefit from fluid linkages should be considered.

A fluid linkage in a steering system has numerous advantages in that:
It permits a simplified vehicle design. With the fluid linkage, there is no need for a mechanical linkage to connect the operator's steering wheel with the vehicle's turning wheels and there is no need for a mechanical linkage to connect the left and right turning wheels together. Thus, the engineer has more flexibility on how turning wheels are attached to a vehicle.
It permits a vehicle to be designed without the need to penetrate the body with a mechanical linkage because left and right turning wheels can be connected without a mechanical linkage. Thus, the body will be stronger and can easily be made airtight and waterproof.
It permits a vehicle to be designed without the need to protect an external mechanical steering linkage from road hazards.
It permits a vehicle to be designed without the need to accommodate the mechanical steering linkage.
It permits a vehicle to be designed without a collapsible steering linkage because no mechanical linkage is required between the operator's steering wheel and the vehicle's turning wheels.
It permits a trailer to follow in the tracks of the towing vehicle because trailer wheels can easily be steered in coordination with the vehicle. Thus, there is a reduced turning radius and much improved handling with no need to take wide turns around corners.
It permits coordination of the turning wheels of the trailer with the turning wheels of the vehicle. Also, it is easy to disable the coordination by disconnecting couplings or stopping fluid flow through valves.
It permits coordinated turning of the vehicle and turning of the trailer, so the trailer tracks the same wheel path as the vehicle. This allows for different modes of operation to be selected depending on the speed of the vehicle or the desired handling characteristics of the operator, whereas a mechanical linkage system can only be efficiently designed for one mode of operation:
a. It permits the steering system to be designed such that on soft surfaces, the trailer wheels can be designed to track the vehicle wheels. Substantially less pulling power is required when the trailer follows in the path already cut by the pulling vehicle.
b. It permits the steering system to be designed such that when passing a vehicle, the trailer wheels will steer with the vehicle wheels to a lesser degree to reduce vehicle spinning, fishtailing, and jackknifing induced by lane changes.
c. It permits the steering system to be designed such that when parking a vehicle, the trailer wheels can be steered in the same direction as the vehicle wheels or in the opposite direction of the vehicle wheels. Also, the trailer wheels can be left stationary. This versatility allows much greater mobility of the vehicle and trailer in parking.
Similarly, it permits the vehicle to have front and rear attachments like a snowplow, snowblower, or lawn mower that can also be steered.
It permits two or more vehicles to be hooked together and the steering of all of these can be coordinated.
It permits complete redundancy in the steering system through identical but independent fluid linkage circuits.

The advantages of using a fluid linkage for self-leveling are as follows:
It permits a simpler and more cost effective design with no mechanical linkage required.
It permits a bucket tip hydraulic cylinder at the end of a telescopic loader to be connected to hydraulic lift cylinders through a fluid linkage.
It permits design of a self-leveling system with a multiple piece lift arm. Several hydraulic lift cylinders will be used to control the multiple piece lift arm. The fluid displaced by these multiple hydraulic lift cylinders from the multiple piece lift arm can be combined to control the self-leveling bucket tip hydraulic cylinder.
It permits self-correction for fluid leakage unlike conventional hydraulic flow divider valves that require adjustment and tuning.
It permits the operator to feel a feed load on the control actuator proportional to servomotor actuator load.
It permits a vehicle operator to detect a reduction of wheel grip on the road through the ability to feel the load on the vehicle turning wheels. Thus, the driver has better vehicle control and can prevent skidding more effectively.
It permits an operator to control and prevent stall through the ability to feel the load on aerodynamic control surfaces.
It permits a crane or excavator operator to perform very delicate work safely through the ability to feel load.

Although the above description contains many specificities, these should not be construed as limiting on the scope of the invention, but as merely providing illustrations of some of the presently preferred embodiments of this invention. Many other variations are possible. For example, instead of using a pump to force pressurized fluid through the fluid circuit of the embodiments described above, external environment pressure could be used to force the fluid through a depressurized fluid circuit. Limit-switch valves can be located such that they activate at one or more intervals along the extension and/or retraction of the piston in the piston actuator. Similarly, limit-switch valves can be located such that they activate at one or more intervals along the rotation of the fluid motor. In the embodiments described above, the piston displacements are in opposite directions in each cylinder. The fluid circuits can instead be easily configured such that the piston displacements are in the same direction in each cylinder. The fluid circuits of the embodiments described above are used to illustrate building blocks and can be structurally combined to construct alternate or more complex fluid circuits.

Thus the scope of the invention should be determined not by the embodiments illustrated, but by the appended claims and their legal equivalents.

What is claimed is:

1. A fluid linkage circuit with the motion of linear or rotary fluid actuators forcibly correlated to provide an effective replacement for mechanical linkages, comprising:
a. linear or rotary fluid actuators that are displaced by fluid and/or displace fluid,
b. fluid control valves that determine the direction of said linear and/or rotary fluid actuators by establishing the direction of fluid flow,
c. fluid conduits for connecting said linear and/or rotary fluid actuators such that fluid flows out of one said linear or rotary fluid actuator into another said linear or rotary fluid actuator with possible intermediary said fluid control valves and boost pumps,
whereby said linear or rotary fluid actuators of said fluid linkage circuit will have their motion forcibly correlated, thus providing an effective replacement for mechanical linkages, and
whereby said linear or rotary fluid actuators of said fluid linkage circuit will have their motion forcibly correlated by one or more said linear or rotary fluid actuators operating one or more said fluid control valves to accurately position one or more said linear or rotary fluid actuators.

2. The fluid linkage circuit of claim 1 further including one or more fluid valves attached to said linear or rotary fluid actuators, such that said fluid valves compensate for fluid loss at certain positions of said linear or rotary fluid actuators and said linear or rotary fluid actuators can be put in the correct relative positions,
whereby fluid loss is compensated for at certain positions of said linear or rotary fluid actuators and said linear or rotary fluid actuators can be put in the correct relative positions, and
whereby the need for immediate fluid loss maintenance is reduced or eliminated, and
whereby the detected fluid loss provides an indication of when and where fluid loss maintenance is required.

3. The fluid linkage circuit of claim 1 further including one or more fluid valves attached to said linear or rotary fluid actuators, such that said fluid valves prevent the pistons of linear fluid actuators from extending or retracting too hard against the cylinder end caps and prevent the rotors of rotary fluid actuators from rotating too hard against the rotor stops if rotor stops exist,
whereby said pistons of said linear fluid actuators are prevented from extending or retracting too hard against the cylinder end caps, and
whereby said pistons of said rotary fluid actuators are prevented from rotating too hard against the rotor stops if rotor stops exist, and
whereby the need for maintenance is reduced and the lifetime of said linear or rotary fluid actuators is increased.

4. A method of connecting linear or rotary fluid actuators forcing their motion to be correlated to replace mechanical linkages, comprising the steps of:
a. forcing fluid from said linear or rotary fluid actuator into another said linear or rotary fluid actuator while possibly traversing through intermediary fluid control valves and boost pumps in the fluid conduit,
b. determining the amount and direction of displacement of said linear or rotary fluid actuators by said fluid control valves establishing the direction and amount of fluid flow in said fluid conduit,
whereby said linear or rotary fluid actuators of said fluid linkage circuit will have their motion forcibly correlated, thus providing an effective replacement for mechanical linkages, and
whereby said linear or rotary fluid actuators of said fluid linkage circuit will have their motion forcibly correlated by one or more said linear or rotary fluid actuators operating one or more said fluid control valves to accurately position one or more said linear or rotary fluid actuators.

5. The method of claim 4 further including a step of compensating for fluid loss at certain positions of said linear or rotary fluid actuators, such that said linear or rotary fluid actuators can be put in the correct relative positions,
whereby fluid loss is compensated for at certain positions of said linear or rotary fluid actuators and said linear or rotary fluid actuators can be put in the correct relative positions, and
whereby the need for immediate fluid loss maintenance is reduced or eliminated, and
whereby the detected fluid loss provides an indication of when and where fluid loss maintenance is required.

6. The method of claim 4 further including a step of preventing the pistons of linear fluid actuators from extending or retracting too hard against the cylinder end caps and preventing the rotors of rotary fluid actuators from rotating too hard against the rotor stops if rotor stops exist,
whereby said pistons of said linear fluid actuators are prevented from extending or retracting too hard against the cylinder end caps, and
whereby said pistons of said rotary fluid actuators are prevented from rotating too hard against the rotor stops if rotor stops exist, and
whereby the need for maintenance is reduced and the lifetime of said linear or rotary fluid actuators is increased.

7. A method of forcibly correlating the motion of connected linear or rotary fluid actuators to replace mechanical linkages, comprising the steps of:
a. forcing fluid from said linear or rotary fluid actuator through a fluid conduit, which possibly includes intermediary fluid control valves and boost pumps, into another said linear or rotary fluid actuator,
b. establishing the direction and amount of fluid flow in said fluid conduit using fluid control valves to determine the amount and direction of displacement of said linear or rotary fluid actuators,
whereby said linear or rotary fluid actuators of said fluid linkage circuit will have their motion forcibly correlated, thus providing an effective replacement for mechanical linkages, and
whereby said linear or rotary fluid actuators of said fluid linkage circuit will have their motion forcibly correlated by one or more said linear or rotary fluid actuators operating one or more said fluid control valves to accurately position one or more said linear or rotary fluid actuators.

8. The method of claim 7 further including a controllable fluid flow completely or partially bypassing said linear or rotary fluid actuators, such that the controllable fluid flow compensates for fluid loss at certain positions of said linear or rotary fluid actuators and said linear or rotary fluid actuators can be put in the correct relative positions,
whereby fluid loss is compensated for at certain positions of said linear or rotary fluid actuators and said linear or rotary fluid actuators can be put in the correct relative positions, and
whereby the need for immediate fluid loss maintenance is reduced or eliminated, and
whereby the detected fluid loss provides an indication of when and where fluid loss maintenance is required.

9. The method of claim 7 further including a controllable fluid flow completely or partially bypassing said linear or rotary fluid actuators, such that the controllable fluid flow prevents the pistons of the linear fluid actuators from extending or retracting too hard against the cylinder end caps and prevents the rotors of rotary fluid actuators from rotating too hard against the rotor stops if rotor stops exist,
whereby said pistons of said linear fluid actuators are prevented from extending or retracting too hard against the cylinder end caps, and
whereby said pistons of said rotary fluid actuators are prevented from rotating too hard against the rotor stops if rotor stops exist, and
whereby the need for maintenance is reduced and the lifetime of said linear or rotary fluid actuators is increased.
